(19) United States
(12) Patent Application Publication
(10) Pub. No.: US 2011/0152113 A1
(43) Pub. Date: Jun. 23, 2011

(54) GENOMIC FINGERPRINT OF BREAST CANCER

(76) Inventors: Ramonón Garcia Escudero, Madrid (ES); Jesús Maria Paramio González, Madrid (ES); Ana Belén Martínez Cruz, Madrid (ES); Mirentxu Santos Lafuente, Madrid (ES)

(21) Appl. No.: 13/002,207

(22) PCT Filed: Jul. 1, 2009
(86) PCT No.: PCT/ES09/70268

§ 371 Date: Feb. 24, 2011

(30) Foreign Application Priority Data
Jul. 2, 2008 (ES) P200802024

(51) Int. Cl. C40B 30/04; C40B 40/06; C40B 40/10; C40B 30/00

(52) U.S. Cl. 506/9; 506/16; 506/18; 506/7

(57) ABSTRACT

The present invention relates to in vitro methods for determining the prognosis of a subject diagnosed with breast cancer developing metastasis or for selecting suitable treatment for said subject. Particularly, the invention relates to a signature of genes the expression of which is correlated with the prognosis of a subject who has been diagnosed with breast cancer.

### FIELD OF THE INVENTION

The present invention relates to in vitro methods for determining the prognosis of a subject diagnosed with breast cancer for developing metastasis or for selecting suitable treatment for said subject.

### BACKGROUND OF THE INVENTION

Breast cancer is the second most common type of cancer worldwide (10.4%, after lung cancer) and the fifth most common cause of cancer-induced death (after lung cancer, stomach cancer, liver cancer, and colon cancer). Breast cancer is the most common cause of cancer-induced death among women worldwide. In 2005, breast cancer caused 502,000 deaths all over the world (7% of cancer-induced deaths; almost 1% of all deaths). The number of cases worldwide has significantly increased since the 1970s, a phenomenon which can partially be attributed to modern Western lifestyles. Women in North America have the highest incidence of breast cancer in the world.

Since the breast is made up of identical tissues in men and women, breast cancer also occurs in men. The incidence of breast cancer in men is approximately 100 times less than in women, but it is considered that men with breast cancer statistically have the same survival rates as women.

Breast cancer is staged according to the TNM system. The prognosis is closely related to the results of the staging, and the staging is also used to assign patients to treatments both in clinical trials and in medical practice. The information for staging is as follows:
TX: The primary tumor cannot be evaluated. T0: There is no evidence of tumor. Tis: Carcinoma in situ, no invasion. T1: The tumor is 2 cm or less across. T2: The tumor is more than 2 cm but less than 5 cm across. T3: The tumor is more than 5 cm across. T4: Tumor of any size growing into the chest wall or skin, or inflammatory breast cancer.
NX: The nearby lymph nodes cannot be evaluated. NO: The cancer has not spread to regional lymph nodes. Ni: The cancer has spread to 1 to 3 underarm lymph nodes or to an internal mammary lymph node. N2: The cancer has spread to 4 to 9 underarm lymph nodes or to multiple internal mammary lymph nodes. N3: Any of the following:
   The cancer has spread to 10 or more underarm lymph nodes, or the cancer has spread to the lymph nodes under the clavicle, or the cancer has spread to the lymph nodes above the clavicle or the cancer affects underarm lymph nodes and has spread to internal mammary lymph nodes, or the cancer affects 4 or more underarm lymph nodes, and small amounts of cancer are found in the internal mammary lymph nodes or in sentinel lymph node biopsy.
MX: The presence of distant spread (metastasis) cannot be evaluated. M0: No distant spread is found. M1: Spread to distant organs is present, these organs not including the lymph node above the clavicle.

The principal pillar of breast cancer treatment is surgery when the tumor is localized, with possible adjuvant hormone therapy (with tamoxifen or an aromatase inhibitor), chemotherapy, and/or radiotherapy. Current recommendations for treatment after surgery (adjuvant therapy) follow a pattern. This pattern is subject to change, because every two years, a world conference is held in St. Gallen, Switzerland to discuss the actual results of multicenter studies conducted worldwide. Likewise, said pattern is also reviewed according to the consensual criterion of the National Institute of Health (NIH). Based on these criteria, over 85-90% of the patients who do not present metastasis in lymph nodes would be candidates for receiving adjuvant systemic therapy.

Today no set of predictors of a satisfactory prognosis based solely on clinical information has been identified. Over the last 30 years oncologists have focused on optimizing the outcome of the cancer patients and it is only now that the new available technologies allow investigating polymorphisms, expression levels of genes and gene mutations for the purpose of predicting the impact of a determined therapy on different groups of cancer patients in order to design customized chemotherapies. PCR assays such as Oncotype DX or microarray assays such as MammaPrint can predict the risk of breast cancer relapse based on gene expression. In February 2007, the MammaPrint assay became the first breast cancer indicator to receive official authorization from the Food and Drug Administration.

Document WO02103320 describes a method for predicting the prognosis of breast cancer patients by means of analyzing the expression of a group of genetic markers, particularly 70 genes (Table 6, page 89). D1 also describes a microarray for determining the prognosis of breast cancer from a sample from a patient comprising probes for detecting the gene expression of said genes.

In addition, document WO2005/083429 describes a method for selecting a genetic marker signature for the prognosis of breast cancer. Said document also describes a method for determining the prognosis of patients with breast cancer by means of analyzing the expression of a group of genes selected from said method. Specifically, said document relates to the use of genetic markers for predicting the prognosis of breast cancer from a characteristic signature consisting of 76 genetic markers. Said document also describes a kit, such as a microarray, for determining the prognosis of breast cancer from a sample from a patient comprising probes for detecting the gene expression of said 76 genes.

Therefore, there is a need to develop new methods which allow identifying the most relevant genes involved in metastasis such that more reliable signatures can be obtained and these signatures can be based on a smaller number of genes. Said signatures will allow predicting the prognosis of a patient suffering breast cancer more efficiently than the methods described in the state of the art. The identification of new prognosis factors will serve as a guideline in selecting the most suitable treatments.

### SUMMARY OF THE INVENTION

In a first aspect, the present invention relates to an in vitro method for determining the prognosis of a subject diagnosed with breast cancer or for selecting the treatment of a subject diagnosed with breast cancer which comprises determining the expression levels of the genes identified in Table 1 and in Table 2 in a tumor tissue sample from said subject, wherein an increase of the expression of the genes identified in Table 1 and a decrease of the expression of the genes identified in Table 2 with respect to a reference value is indicative of a worse prognosis or of said subject having to be treated with chemotherapy.

In a second aspect, the invention relates to a reagent capable of detecting the expression levels of the genes of Tables 1 and 2.

In another aspect, the invention relates to a kit comprising at least one reagent according to the invention.

In another aspect, the invention relates to the use of a kit according to the invention for the prognosis of patients diagnosed with breast cancer or for selecting the treatment of a subject diagnosed with breast cancer.

The invention also relates in another aspect to a method for selecting genetic markers for predicting the tendency to develop metastasis of a primary tumor comprising the following steps:
i) determining the genes the expression of which is altered with respect to a reference value in a tumor sample from a genetically modified non-human animal showing a tendency to develop tumors spontaneously;
ii) identifying the homologous genes in humans corresponding to the genes identified in step i); and
iii) selecting those genes identified in step ii) the expression of which in primary tumor samples from patients who develop metastasis from said primary tumor is altered with respect to the expression of said genes in primary tumors of patients who do not develop metastasis.

### BRIEF DESCRIPTION OF THE DRAWINGS

FIG. 1 shows Receiver Operating Curves (ROC) of predicting the genetic signature of the invention, in the complete Loi dataset (n=191), or in the Loi dataset excluding grade 3 ER− samples (n=142). Panels A and C show the prediction of distant metastasis (DM) at 5 years, and panel E shows the prediction of overall survival at 5 years. Panels B and D show the prediction of distant metastasis (DM) at 10 years, and panel E shows the prediction of overall survival at 10 years. The RV of the point of maximum Specificity (40.1%) and Sensitivity (100%) of panel A was chosen as the threshold for separating into samples of good or poor prognosis (RV=−39.2) (circle).

FIG. 2 shows survival curves or prognostic prediction of patients not treated with tamoxifen, and N− within the Loi dataset (86 tumors, diameter≦5 cm).

FIG. 3 shows survival curves or prognostic prediction of patients treated with tamoxifen, and N+ within the Loi dataset (108 tumors, diameter≦5 cm).

FIG. 4 shows the genetic signature of the invention in the Desmedt dataset. The left panel shows an expression map of the genes the sequences of which hybridize with the probes of the signature of the invention in the Desmedt tumors, excluding the grade 3 ER− (142 samples). The columns represent genes, and the rows represent samples. The genes are arranged from left to right according to decreasing values of the Wald statistic value in accordance with Table 2. The expression values are shown as log₂ (mean=0, standard deviation=1).

The right panel shows the prediction results using the signature of genes of the invention, or using the criteria of St. Gallen (SG), NIH, Nottingham Prognostic Index (NPI), Adjuvant Online (AOL), and the 76-gene genomic signature of Veridex. Samples in light gray indicate a good prognosis; samples in dark gray indicate a poor prognosis. The presence of 37 probes, the expression of which is higher in the poor prognosis samples, can be observed. The ER status (ER+ in black, ER− in white), as well as the existence of DM at 5 or 10 years (presence of metastasis in white, absence in black), are shown. The genes are represented both by the Affymetrix probe identifiers, and by the NCBI gene symbols.

FIG. 5 shows the genetic signature of the invention in the Loi dataset. A) The left panel shows an expression map of the genes the sequences of which hybridize with the probes in the Loi tumors, which were N− and were not treated with tamoxifen, excluding grade 3 ER− (86 samples). The columns represent genes and the rows represent samples. The genes are arranged from left to right according to decreasing values of the Wald statistic value in accordance with Table 2. The expression values are shown as log₂ (mean=0, standard deviation=1).

The right panel shows the prediction results using the signature of genes of the invention, or the criteria of St. Gallen (SG) and NIH. Samples in light gray indicate a good prognosis; samples in dark gray indicate a poor prognosis. The presence of 37 probes, the expression of which is greater the poor prognosis samples, can be observed. The ER status (ER+ in black, ER− in white), as well as the existence of DM at 5 or 10 years (presence of metastasis in white, absence in black), are shown. The genes are represented both by the Affymetrix probe identifiers and by the NCBI gene symbols.

B) This panel is similar to panel A, but it is for the group of 108 patients of the Loi dataset who were N+ and received hormone therapy.

FIG. 6 shows the ranking of the genes selected in the comparison between murine tumors p53- and p53-; pRb- and normal skin. The genes which are overexpressed in mouse tumors arranged according to the magnitude of the relative change in gene expression (from 80.3 up to 1.2 times, panel A), or arranged by the P value (panel C), computed according to the Student's t-Test. The black color in the left column indicates genes increased more than 2 times. The dark gray in the central column indicates genes which also met the differential expression criteria of the SAM test. The position within the range of the equivalent mouse genes of the signature of genes of the invention in humans is indicated in the right column. Genes the name of which appears in dark gray are overexpressed in malignant human breast tumors; genes in light gray are decreased in malignant tumors

Genes having a reduced expression in the mouse tumors arranged according to the magnitude of the relative change in gene expression (from 375.8 up to 1.2 times, panel B), or arranged by the P value (panel D), computed according to the Student's t-Test. The black color of the left column indicates genes regulated negatively by more than 2 times. The dark gray in the column central indicates genes which also met the differential expression criteria of the SAM test. The position within the range of the equivalent mouse genes of the signature of genes in humans is indicated in the right column. Genes the name of which appears in dark gray are overexpressed in malignant human breast tumors; genes in light gray are decreased in malignant tumors.

### DETAILED DESCRIPTION OF THE INVENTION

The authors of the present invention have selected a signature of genes which hybridize with probes and the expression of which is correlated with the prognosis of a subject who has been diagnosed with breast cancer. Said signature can also be used for selecting the most suitable treatment for said subject diagnosed with breast cancer.

As hereinbefore mentioned, the criteria of St. Gallen and of the NIH classify patients as high risk or low risk based on several histological and clinical characteristics. The authors of the present invention have demonstrated that said prognostic signature of the invention assigns more patients to the low risk (or good prognosis) group than the traditional methods do. In fact, the inventors have shown that said clinical criteria mistakenly classify a clinically significant number of patients in the poor prognosis group, so in current clinical practice many patients are receiving chemotherapy unnecessarily.

Therefore, in a first aspect the invention relates to an in vitro method for determining the prognosis of a subject diagnosed with breast cancer or for selecting the treatment of a subject diagnosed with breast cancer which comprises determining the expression levels of the genes identified in Table 1 and in Table 2 in a tumor tissue sample from said subject, wherein an increase of the expression of the genes identified in Table 1 and a decrease of the expression of the genes identified in Table 2 with respect to a reference value is indicative of a worse prognosis or of said subject having to be treated with chemotherapy. In a particular embodiment of the invention, said tumor tissue sample is a primary tumor sample, particularly, said tumor is breast cancer. Thus, by way of illustration said tumor tissue sample can be a biopsy sample obtained, for example, by surgical resection.

In a particular embodiment of the method of the invention, said genes are the genes the nucleotide sequences of which hybridize with the probes identified in Table 1 and Table 2.

TABLE 1

Gene symbol
TOP2A
TOMM70A
PLK1
CCNB2
UBEC2C
SPAG5
CDC2
MAD2L1
BUB1B
TRIP13
AURKA
KIF11
BRCA1
HMMR
CIAPIN1
LRP8
AURKB
CDKN3
HSP90AA1
NUSAP1
ERO1L
MLF1IP
DCC1
C21orf45
PBK
ATAD5
MCM10
CDCA3
RACGAP1

TABLE 2

Gene symbol
ELOVL5
PARP3
CBX7

TABLE 3

| Symbol | SEQ ID NO |
|---|---|
| TOP2A | SEQ ID NO: 1-SEQ ID NO: 11 |
| TOP2A-2 | SEQ ID NO: 12-SEQ ID NO: 22 |
| TOMM70A | SEQ ID NO: 23-SEQ ID NO: 33 |
| PLK1 | SEQ ID NO: 34-SEQ ID NO: 44 |
| CCNB2 | SEQ ID NO: 45-SEQ ID NO: 55 |
| UBEC2C | SEQ ID NO: 56-SEQ ID NO: 66 |
| SPAG5 | SEQ ID NO: 67-SEQ ID NO: 77 |
| CDC2 | SEQ ID NO: 78-SEQ ID NO: 88 |
| CDC2-2 | SEQ ID NO: 89-SEQ ID NO: 99 |
| MAD2L1 | SEQ ID NO: 100-SEQ ID NO: 110 |
| BUB1B | SEQ ID NO: 111-SEQ ID NO: 121 |
| TRIP13 | SEQ ID NO: 122-SEQ ID NO: 132 |
| AURKA | SEQ ID NO: 133-SEQ ID NO: 143 |
| KIF11 | SEQ ID NO: 144-SEQ ID NO: 154 |
| BRCA1 | SEQ ID NO: 155-SEQ ID NO: 165 |
| HMMR | SEQ ID NO: 166-SEQ ID NO: 176 |
| CIAPIN1 | SEQ ID NO: 177-SEQ ID NO: 187 |
| LRP8 | SEQ ID NO: 188-SEQ ID NO: 198 |
| CIAPIN1-2 | SEQ ID NO: 199-SEQ ID NO: 209 |
| AURKB | SEQ ID NO: 210-SEQ ID NO: 220 |
| HMMR-2 | SEQ ID NO: 221-SEQ ID NO: 231 |
| CDKN3 | SEQ ID NO: 232-SEQ ID NO: 242 |
| HSP90AA1 | SEQ ID NO: 243-SEQ ID NO: 253 |
| BRCA1-2 | SEQ ID NO: 254-SEQ ID NO: 264 |
| HSP90AA1-2 | SEQ ID NO: 265-SEQ ID NO: 275 |
| HSP90AA1-3 | SEQ ID NO: 276-SEQ ID NO: 286 |
| HSP90AA1-4 | SEQ ID NO: 287-SEQ ID NO: 297 |
| NUSAP1 | SEQ ID NO: 298-SEQ ID NO: 308 |
| ERO1L | SEQ ID NO: 309-SEQ ID NO: 319 |
| MLF1IP | SEQ ID NO: 320-SEQ ID NO: 330 |
| DCC1 | SEQ ID NO: 331-SEQ ID NO: 341 |
| C21orf45 | SEQ ID NO: 342-SEQ ID NO: 352 |
| PBK | SEQ ID NO: 353-SEQ ID NO: 363 |
| ATAD5 | SEQ ID NO: 364-SEQ ID NO: 374 |
| MCM10 | SEQ ID NO: 375-SEQ ID NO: 385 |
| CDCA3 | SEQ ID NO: 386-SEQ ID NO: 396 |
| RACGAP1 | SEQ ID NO: 397-SEQ ID NO: 407 |

TABLE 4

| Symbol | SEQ ID NO |
|---|---|
| ELOVL5 | SEQ ID NO: 408-SEQ ID NO: 418 |
| PARP3 | SEQ ID NO: 419-SEQ ID NO: 429 |
| CBX7 | SEQ ID NO: 430-SEQ ID NO: 440 |

The quantification of the expression levels of the genes identified in Table 1 and in Table 2 can be performed from the

RNA resulting from the transcription of said genes (mRNA) or, alternatively, from the complementary DNA (cDNA) of said genes. Therefore, in a particular embodiment, the quantification of the expression levels of the genes identified in Table 1 and in Table 2 comprises the quantification of the messenger RNA (mRNA) of said genes, or a fragment of said mRNA, the complementary DNA (cDNA) of said genes, or a fragment of said cDNA, or mixtures thereof.

Additionally, the method of the invention can include performing an extraction step for the purpose of obtaining the total RNA, which can be performed by means of conventional techniques (Chomczynski at al., Anal. Biochem., 1987, 162:156; Chomczynski P., Biotechniques, 1993, 15:532).

Virtually any conventional method can be used within the invention for detecting and quantifying the levels of mRNA encoded by the genes the nucleotide sequences of which hybridize with the probes of Tables 1 and 2 or of the corresponding cDNA thereof. By way of non-limiting illustration, the levels of mRNA encoded by said genes can be quantified by means of using conventional methods, for example, methods comprising the amplification of the mRNA and the quantification of the said mRNA amplification product, such as electrophoresis and staining, or alternatively, by means of Northern blot and using suitable probes, Northern blot and using probes specific for mRNA of the genes of interest or of the corresponding cDNA thereof, mapping with the S1 nuclease, RT-PCR, hybridization, microarrays, etc. Similarly, the levels of the cDNA corresponding to said mRNA encoded by the genes of Tables 1 and 2 can also be quantified by means of using conventional techniques; in this case, the method of the invention includes a step of synthesizing the corresponding cDNA by means of reverse transcription (RT) of the corresponding mRNA followed by amplification and quantification of the said cDNA amplification product. Conventional methods of quantifying expression levels can be found, for example, in Sambrook et al., 2001 “Molecular cloning: a Laboratory Manual”, 3^{rd} ed., Cold Spring Harbor Laboratory Press, N.Y., Vol. 1-3.

In a particular embodiment of the invention, the quantification of the expression levels of the genes identified in Tables 1 and 2 is performed by means of a quantitative multiplex polymerase chain reaction (PCR) or a DNA or RNA array.

In another particular embodiment of the invention, the determination of the expression levels of the genes identified in Table 1 and Table 2 is performed by means of a DNA array comprising the probes identified in Tables 3 and 4. In a more particular embodiment of the invention, said array comprises at least one set of 11 probes for determining the expression levels of each of the genes of Tables 1 and 2. Thus, for determining the expression levels of each of said genes, a mean of the signal of said 11 probes used for detecting the expression of said gene is calculated.

Thus, said method comprises determining the expression levels of said genes of Tables 1 and 2 with respect to a reference value. In a particular embodiment of the invention, said reference value is the gene expression value of said genes of Tables 1 and 2 in a primary tumor sample from patients who do not develop metastasis. Preferably, it will be considered that the genes present increased expression when the expression ratio of a gene is at least 1.5 times with respect to a reference value, preferably greater than 2 times, more preferably greater than 3, 4, 5 and 10 times. Likewise, in a particular embodiment of the invention, it will be considered that the genes present decreased expression with respect to a reference value when the expression ratio of a gene is at least 1.5 times less than the reference value.

In a particular embodiment of the invention, the method for determining the better or worse prognosis of a subject who has been diagnosed with breast cancer comprises performing a proportional hazards regression analysis depending on said expression values of the genes identified in Tables 1 and 2. According to the data shown in Example 2, the authors have demonstrated that in this manner, said prognosis is performed with an effectiveness which, according to the ROC curves, would have a sensitivity of 100% as well as maximum specificity. Therefore, in a particular embodiment of the invention, the determination of said prognosis comprises a proportional hazards regression analysis of said prognosis depending on the expression levels of the genes identified in Table 1 and in Table 2.

As is described in Example 2 enclosed in the present description, the inventors have used a Cox-type proportional hazards regression analysis for determining the prognosis of a subject diagnosed with breast cancer. Said Cox analysis assigns a regression coefficient for each gene, such that the gene the expression of which is directly correlated with the prognostic variable, for example with the onset of metastasis, is >0, and if its expression is inversely related to said variable, it is <0. Therefore, in a particular embodiment of the invention, said proportional hazards regression analysis is a Cox-type analysis. In a more particular embodiment, distant metastasis is established in said Cox-type analysis as a prognostic variable. In a preferred embodiment, said distant metastasis is distant metastasis at 5 or 10 years.

The inventors have demonstrated that by means of the method of the invention it is possible to determine the prognosis of a patient with high sensitivity and specificity. Thus, from the gene expression values for the genes of Tables 1 and 2 as has been hereinbefore described, and from the value of the Wald statistic of the proportional hazards regression analysis, the inventors have demonstrated that it is possible to determine said prognosis by applying the following formula:

$${\sum }_{i = 1}^{40} {s}_{i} \cdot {x}_{i} + 39.2$$

wherein xᵢ is the value of the expression level in log2 of each of said genes identified in Tables 1 and 2; and sᵢ is the value of the Wald statistic of the Cox-type regression analysis for each of said genes identified in Tables 1 and 2,

wherein if the value obtained is greater than zero, then it is indicative of said patient presenting a worse prognosis or of said patient having to be treated with chemotherapy, and wherein if said value is less than zero, it is indicative of said patient presenting a good prognosis or of said patient not having to be treated with chemotherapy.

The value of the Wald statistic is a value commonly used by the person skilled in the art to known whether or not the variables which are introduced in the statistical analysis are relevant. Said value can be calculated as described in Wald A. (1943) (Transactions of the American Mathematical Society. 1943; 54:426-482) and Silvey (1959) (Silvey S D. Annals of Mathematical Statistics. 1959; 30:389-407).

In addition, besides quantifying the expression levels of the genes identified in Tables 1 and 2, the expression level of the proteins encoded by said genes can also be quantified for putting the invention into practice. Thus, in a Particular embodiment the quantification of the levels of the proteins encoded by the genes identified in Tables 1 and 2 comprises the quantification of said proteins or variables thereof.

As it is used herein, the term “protein” relates to a molecular chain of amino acids attached by covalent or non-covalent bonds. The term further includes all the physiologically relevant forms of post-translational chemical modifications, for example, glycosylation, phosphorylation or acetylation, etc.

In the present invention “variant” is understood as a protein the amino acid sequence of which is substantially homologous to the amino acid sequence of a specific protein. An amino acid sequence is substantially homologous to a determined amino acid sequence when it presents at least a 70% degree of identity, advantageously at least 75%, typically at least 80%, preferably at least 85%, more preferably at least 90%, still more preferably at least 95%, 97%, 98% or 99%, with respect to said determined amino acid sequence. The degree of identity between two amino acid sequences can be determined by conventional methods, for example, by means of standard sequence alignment algorithms known in the state of the art, such as BLAST [Altschul S. F. et al. Basic local alignment search tool. J Mol Biol. 1990 Oct. 5; 215(3):403-10], for example.

The person skilled in the art understands that the mutations in the nucleotide sequence of the genes which give rise to conservative substitutions of amino acids in non-critical positions for protein functionality are mutations with a neutral evolution which do not affect its overall structure or its functionality. Said variants fall within the scope of the present invention.

Therefore, as it is used herein, the term “variant” also includes any fragment of one of the proteins described in the present invention. The term “fragment” relates to a peptide comprising a portion of a protein.

The expression level of the proteins encoded by the genes identified in Tables 1 and 2 can be quantified by means of any conventional method which allows detecting and quantifying said proteins in a sample from a subject. By way of non-limiting illustration, the levels of said proteins can be quantified, for example, by means of using antibodies with the capacity to bind to said proteins (or to fragments thereof containing an antigenic determinant) and the subsequent quantification of the formed complexes. The antibodies which are used in these assays can be labeled or not. Illustrative examples of markers which can be used include radioactive isotopes, enzymes, flourophores, chemiluminescent reagents, enzyme substrates or cofactors, enzyme inhibitors, particles, dyes, etc. There is a wide range of known assays that can be used in the present invention which use non-labeled antibodies (primary antibody) and labeled antibodies (secondary antibody); these techniques include Western blot, ELISA (Enzyme-linked Immunosorbent Assay), RIA (Radioimmunoassay), competitive EIA (Competitive Enzyme Immunoassay), DAS-ELISA (Double Antibody Sandwich ELISA), immunocytochemical and immunohistochemical techniques, techniques based on using protein biochips or microarrays which include specific antibodies or assays based on colloidal precipitation in formats such as dipsticks. Other ways of detecting and quantifying said proteins include affinity chromatography techniques, ligand binding assays, etc.

In a particular embodiment, the quantification of the levels of protein encoded by the genes identified in Tables 1 and 2 is performed by means of Western blot, ELISA, immunohistochemistry or a protein array.

As hereinbefore mentioned, the in vitro method of the invention can be used for selecting the treatment of a subject diagnosed with breast cancer, wherein an increase of the expression of the genes identified in Table 1 and a decrease of the expression of the genes identified in Table 2 with respect to a reference value is indicative of said subject having to be treated with chemotherapy.

The suitable chemotherapy agents include but are not limited to alkylating agents such as, for example, cyclophosphamide, carmustine, daunorubicin, mechlorethamine, chlorambucil, nimustine, melphalan and the like; anthracylines, such as, for example, daunorubicin, doxorubicin, epirubicin, idarubicin, mitoxantrone, valrubicin and the like; taxane compounds, such as, for example, paclitaxel, docetaxel and the like; topoisomerase inhibitors such as, for example, etoposide, teniposide, irinotecan, tuliposide and the like; nucleotide analogues such as, for example, azacitidine, azathioprine, capecitabine, cytarabine, doxifluridine, fluorouracil, gemcitabine, mercaptopurine, methotrexate, thioguanine ftorafur and the like; platinum-based agents such as, for example, carboplatin, cisplatin, oxaliplatin and the like; anti-neoplastic agents such as, for example, vincristine, leucovorin, lomustine, procarbazine and the like; hormone modulators such as, for example, tamoxifen, finasteride, 5-α-reductase inhibitors and the like; vinca alkaloids such as, for example, vinblastine, vincristine, vindesine, vinorelbine and the like. The suitable chemotherapy agents are described in detail in the literature, such as in The Merck Index in CD-ROM, 13^{th} edition.

In the present invention, “antitumor agent” is understood as that chemical, physical or biological agent or compound with antiproliferative, antioncogenic and/or carcinostatic properties which can be used to inhibit tumor growth, proliferation and/or development. Examples of antitumor agents which can be used in the present invention are (i) antimetabolites, such as antifolates and purine analogues; (ii) natural products, such as antitumor antibiotics and mitotic inhibitors; (iii) hormones and antagonist thereof, such as androgens and corticosteroids; and (iv) biological agents, such as viral vectors. A list of compounds which can be used as antitumor agents is described in patent application WO2005/112973.

In another aspect, the present invention relates to a reagent, hereinafter reagent of the invention, capable of detecting the expression levels of the genes of Tables 1 and 2.

In a particular embodiment, said reagent of the invention comprises
(i) a set of nucleic acids comprising the nucleotide sequences of the probes identified in Tables 3 and 4 or the products of their transcription, or
(ii) a set of antibodies, or a fragment thereof, capable of detecting an antigen, consisting of each antibody or fragment being capable of binding specifically to one of the proteins encoded by the genes identified in Tables 1 and 2.

In a particular embodiment of the invention, said nucleic acids are DNA, cDNA or RNA probes and/or primers. Said nucleic acids can be obtained by conventional techniques known by the person skilled in the art from the nucleotide sequences of the genes of Tables 1 and 2. Said probes and/or primers can generally be obtained from companies by chemical synthesis. In addition, said sequences of said genes are well described in the literature and are therefore known.

In another aspect, the present invention relates to a kit comprising at least one reagent according to the invention. In a particular embodiment of the invention, said kit is a DNA or RNA array comprising a set of nucleic acids, wherein said set of nucleic acids comprises the nucleotide sequences of the probes of Tables 3 and 4, or a fragment thereof, or the products of their transcription. In a more particular embodiment, said kit further comprises a nucleic acid molecule of one or several constitutive expression genes.

In the present invention “genes which are expressed constitutively” or “constitutive expression genes” is understood as those genes that are always active or which are constantly transcribed. Examples of genes which are expressed constitutively are 2-myoglobin, ubiquitin, 18S ribosomal protein, cyclophilin A, transferrin receptor, actin, GAPDH, tyrosine 3-monooxygenase/tryptophan 5-monooxygenase activation protein (YWHAZ), ubiquitin, beta-actin and β-2-microglobulin.

In another particular embodiment of the invention, the kit of the invention comprises a set of antibodies, wherein said set of antibodies consists of antibodies or fragments thereof capable of binding specifically with the proteins encoded by the genes identified in Tables 1 and 2 or any variant of said proteins. In a particular embodiment, said kit further comprises antibodies or fragments thereof capable of binding specifically with the proteins encoded by one or several constitutive expression genes.

The term genetic signature or signature of genes of the invention as it is herein used relates to the genes identified in Tables 1 and 2. According to the data shown by the inventors (see Example 4), the signature of genes or genetic signature of the invention assigns more patients to the low risk (or good prognosis) group than traditional methods do. Thus, the inventors have demonstrated that the patients classified as poor prognosis patients according to the method of the present invention tend to have a greater proportion of metastasis than the poor prognosis patients according to the clinical criteria of St Gallen and NIH. Therefore, in another aspect, the invention relates to the use of a kit according to the invention for the prognosis of patients diagnosed with breast cancer or for selecting the treatment of a subject diagnosed with breast cancer.

In another aspect, the invention relates to a method for selecting genetic markers for predicting the tendency to develop metastasis of a primary tumor comprising the following steps:
i) determining the genes the expression of which is altered with respect to a reference value in a tumor sample from a genetically modified non-human animal showing a tendency to develop tumors spontaneously;
ii) identifying the homologous genes in humans corresponding to the genes identified in step i); and
iii) selecting those genes identified in step ii) the expression of which in primary tumor samples from patients who develop metastasis from said primary tumor is altered with respect to the expression of said genes in primary tumors of patients who do not develop metastasis.

For determining the genes the expression of which is altered according to step i), first a sample is obtained from said animal, preferably said sample is a tumor tissue sample. Example 1 of the present invention describes a particular embodiment of the method of the invention. Thus, in a particular embodiment, the total RNA is extracted from said tumor tissue sample of said animal and said RNA is analyzed to determine the genes the expression of which is altered in said tumor sample with respect to a reference value. In a particular embodiment, said reference value is the gene expression value in a non-tumor tissue sample from said animal. Said expression value can be obtained, for example, from the values resulting from the gene expression signal in a gene expression array of said non-human animal model as is explained in Example 1 of the present description. Thus, said values correspond with the values in the CEL (CEL format) type files according to the GCOS (GeneChip® Operating Software) software of Affymetrix.

In a particular embodiment of the method for selecting genetic markers of the invention, said non-human animal is an animal in which the gene expression of the Tp53 gene is inhibited. In another particular embodiment, the gene expression of the pRb gene is further inhibited in said animal. The Tp53 and Rb1 genes respectively encode tumor suppressors p53 and pRb. Said animal models, with a deficiency of the p53 and pRb genes (p53- and pRb-), spontaneously develop highly invasive epidermal carcinomas. Therefore, in a particular embodiment, said animal is a non-human animal which spontaneously develops epidermal carcinomas.

To carry out step ii) of the method for selecting genetic markers for predicting the tendency to develop metastasis of a primary tumor, the homologous genes in humans corresponding to the genes identified in step i) are identified. To that end, conventional techniques for mapping homologous genes known by the person skilled in the art are used. Particularly, the inventors have mapped the Affymetrix probe identifiers of the non-human animal with human gene symbols through the search for identifiers in U133plus 2.0 and U133A by means of using the AILUN (Array Information Library Universal Navigator) web utility (Chen R, et al. Nat Methods 2007; 4(11):879).

In a final step of said method, those genes identified in step ii) the expression of which in primary tumor samples from patients who develop metastasis from said primary tumor is altered with respect to the expression of said genes in primary tumors of patients who do not develop metastasis are selected.

In a particular embodiment of the invention, step iii) is carried out by means of a proportional hazards regression analysis as hereinbefore mentioned. In a more particular embodiment, said regression analysis is a Cox-type analysis. In a preferred embodiment, said Cox-type method establishes distant metastasis as a prognostic variable. In an even more preferred embodiment of the invention, said distant metastasis is distant metastasis at 5 or 10 years.

The inventors have further applied the Wald test (Wald A. Transactions of the American Mathematical Society 1943; 54:426-482; Silvey S D. Annals of Mathematical Statistics 1959; 30389-407) to analyze the null hypothesis that the coefficient is 0 (not related to the prognostic variable), a Wald statistic value, the corresponding P value, and P value corrected by the FDR (false discovery rate) method as explained in Example 2 of the present description, being assigned to each gene. FDR control is a statistical method known by the person skilled in the art used in multiple hypothesis testing for correcting multiple comparisons.

In a particular embodiment of the invention, said primary tumors according to step iii) are breast cancer tumors.

In a particular embodiment, the determination of the expression of said genes according to step iii) comprises the quantification of the messenger RNA (mRNA) of said genes, or a fragment of said mRNA, the complementary DNA (cDNA), or a fragment of said cDNA, or mixtures thereof.

In a more particular embodiment, the quantification of the expression levels of the genes according to step iii) is performed by means of a quantitative multiplex polymerase chain reaction (PCR) or a DNA or RNA array.

In a particular embodiment, the quantification of the expression levels of the genes according to step iii) comprises the quantification of the levels of protein encoded by said genes. In a more particular embodiment, the quantification of the levels of protein is performed by means of Western blot, ELISA or a protein array.

The following Examples illustrate the invention and must not be interpreted as limiting of the scope thereof.

### EXAMPLE 1

### Analysis of Mouse Epidermal Tumors

The animal models used in the present invention are K14Cre mice (they express Cre recombinase in the basal layer of stratified epithelia) crossed with mice with essential exons flanked by loxP sequences in the alleles of the Tp53 genes (p53- model), or in the Tp53 and Rb1 alleles simultaneously (p53- model; pRb- model) (Martinez-Cruz A B. et al. Cancer Res 2008; 68(3):683-692). Tp53 and Rb1 respectively encode tumor suppressors p53 and pRb. Therefore they are gene deletion models in stratified epithelia. Both models spontaneously develop highly invasive poorly differentiated or undifferentiated type epidermal squamous cell carcinomas.

RNA from frozen epidermal carcinomas which occurred in mice deficient in p53 (p53-) (7 tumors) and deficient in p53 and pRb (p53-/pRb-) (8 tumors) was purified. RNA from normal skin preserved in RNAlater from adult animals (8 weeks old, 5 control samples) was obtained as controls. The integrity of the RNA populations was checked by means of using the Bioanalyzer system (Agilent). All the RNA samples met the quality criteria for microarray analysis (RIN number (RNA integrity number) above 6). Hybridization to the Affymetrix GeneChip, Mouse Gene Expression MOE430 2.0, was performed in the Genomic Department of the Cancer Research Center of Salamanca, using standard Affymetrix protocols. The expression values were extracted from the CEL files (resulting from the fluorescence scanning according to the Affymetrix GCOS software (GeneChip® Operating Software) by means of the RMA (Robust Multichip Average) method (Boistad B M, at al. Bioinformatics 2003; 19(2):185-193; Irizarry R A, et al. Biostatistics 2003; 4(2):249-264). All the hybridizations met the quality criteria included in the RMAExpress computer program using RLE (Relative Log Expression) and MUSE (Normalized Unscaled Standard Error) graphics.

The analysis of differential gene expression of the mouse tumors compared with normal tissue were performed by means of the Student's t-Test (T-test) and SAM (Significant Analysis of Microarrays) (Tusher V G, et al. Proc Natl Acad Sci U S A 2001; 98(9):5116-5121) in the free Multiexperiment Viewer 4.0 software (MeV 4) (Saeed A I, et al. Biotechniques 2003; 34(2):374-378). The probes were selected if they met two criteria: i) T-test analysis with probability P value, corrected by the False Discovery Rate method (Benjamini Y, Hochberg Y. Journal of the Royal Statistical Society B 1995; 57:289-300) or FDR<3×10⁻⁷; and ii) SAM analysis with FDR<1×10⁻³. A total of 682 probes were selected as differentially expressed, 371 being overexpressed and 311 being negatively regulated in the tumors compared to normal tissue. The Affymetrix identifiers of the chip used (MOE430 2.0) were mapped to the homologous human gene symbol using the Ailun web utility (Chen R, et al. Nat Methods 2007; 4(11):879), which resulted in 427 human genes.

### EXAMPLE 2

### Two-Step Extraction of a Breast Cancer Metastasis Predictor Based on a p53 Signature.

2.1 Selection of Genes with the p53 Signature Related to Metastasis.

The raw data on the hybridization to microarrays of human primary breast tumors and their corresponding clinical data, obtained with the versions of Affymetrix Human Gene Expression U133A or U133Plus 2.0 GeneChips were downloaded from the Gene Expression Omnibus (GEO) web page database of the NCBI, with the identifiers GSE7390 (Desmedt C. et al. Clin Cancer Res 2007; 13(11):3207-3214) (study hereinafter referred to as Desmedt dataset) and GSE6532 (Loi S. at al. J Clin Oncol 2007; 25(10):1239-1246) (study hereinafter referred to as Loi dataset). The CEL files were taken to extract the signal intensity values using the RMAExpress program. The RLE and NUSE graphics allowed identifying some tumor microarrays which did not meet the optimal normalization criteria with RMA. The corresponding CEL files were removed from subsequent analyses.

The Desmedt dataset was used as a training set which, after removing the low-quality arrays, contained 191 tumors with healthy lymph nodes (N−), including both samples which express estrogen receptor and samples which do not (ER+ or ER−, respectively) from patients who have not received adjuvant systemic therapy (Table 5).

TABLE 5
Clinical and pathological characteristics
of the patients of the Desmedt dataset

| | Desmedt dataset | |
|---|---|---|
| | (n = 191) | |
| Age (years) | | |
| Mean | 46 | years |
| <45 | 78 | (41%) |
| 45-65 | 113 | (59%) |
| >65 | 0 | (0%) |
| Size (cm) | | |
| <1 | 8 | (4%) |
| 1-2 | 90 | (47%) |
| >2-5 | 93 | (49%) |
| Degree of tumor | | |
| differentiation | | |
| Poor | 81 | (42%) |
| Moderate | 80 | (42%) |
| Good | 28 | (15%) |
| Unknown | 2 | (1%) |
| ER status | | |
| Positive | 128 | (67%) |
| Negative | 63 | (33%) |
| Distant metastasis | | |
| after 5 years | | |
| Yes | 34 | (18%) |
| No | 149 | (78%) |
| Censored | 8 | (4%) |

The data are numbers of patients, or percentages of patients.
TM = tamoxifen

A Cox-type proportional hazards regression analysis was performed using distant metastasis (DM) at 5 years for the 707 U133A probes (and also present in U133Plus 2.0) corresponding to the 427 genes humans mapped from the analysis of differential expression of the mouse tumors, using the survival utility implemented on the GEPAS web page (www.gepas.org) (Vaquerizas J M. et al. Nucleic Acids Res 2005; 33 (Web Server issue):W616-620).

Briefly, the Cox analysis assigns a Cox regression coefficient for each probe, such that a probe the expression of which is directly correlated with the occurrence of DM is >0, and if its expression is inversely related to DM it is <0. Furthermore the Wald test (Wald A. Transactions of the American Mathematical Society 1943; 54:426-482; Silvey S D. Annals of Mathematical Statistics 1959; 30:389-407) is applied to analyze the null hypothesis that the coefficient is 0 (not related to DM), a Wald statistic value, the corresponding P value, and P value corrected by the FDR method, being assigned to each probe. The probes with Wald statistic values >3 or <−3 were chosen for subsequent analyses. The purpose of these analyses is to check the DM prediction capacity DM at 5 and 10 years of human breast cancer.

### 2.2 Development of a Mathematical Model for the Prediction of Metastasis.

A formula was obtained to calculate a “risk value” (RV) of each tumor based on the described genes:

$$Risk value ( R V ) = {\sum }_{i = 1}^{40} {s}_{i} \cdot {x}_{i}$$

wherein sᵢ is the Wald statistic of the Cox-type regression analysis; and
xᵢ is the expression value in log2 of the Affymetrix probe (mean=1; standard deviation=1)
Table 6 indicates the genes of the signature of the invention and the corresponding values of sᵢ

Said formula assigns a numerical value to each sample (RV) based on the sum of the products of the expression values of each gene and the values of the Wald statistic of each gene according to the Cox model hereinbefore explained (see Table 7).

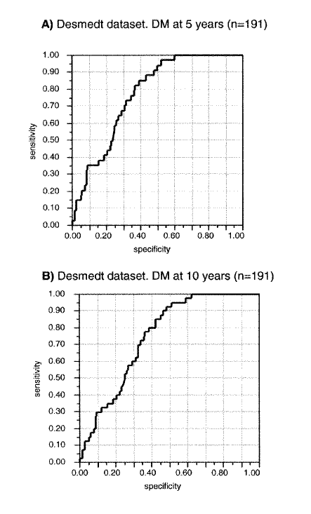

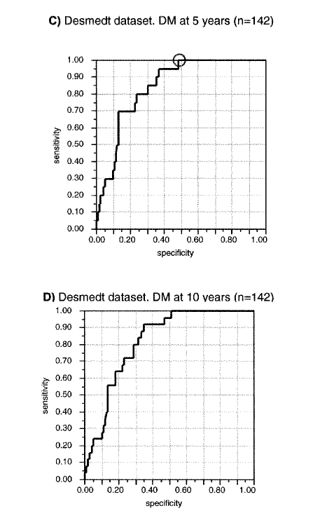

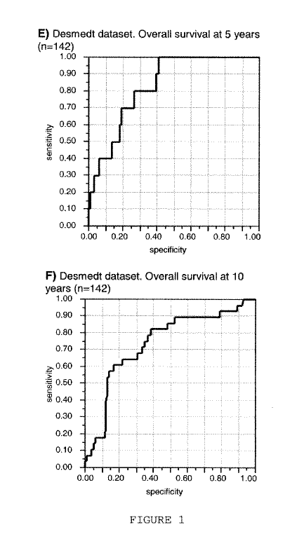

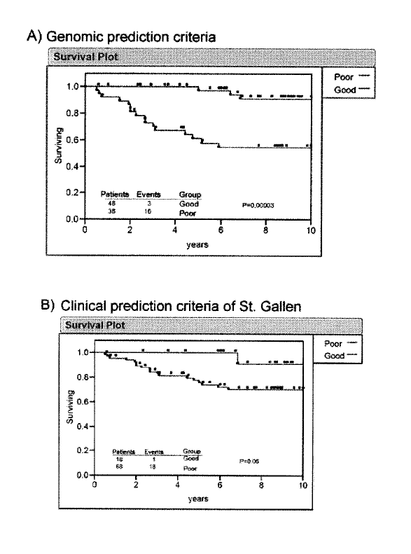

The RV values of the 191 tumors of the Desmedt dataset were obtained according to the RV formula described above. Receiver Operating Curves (ROC) were computed for the RV using the variable of DM at 5 years as the censored dependent variable. As is shown in FIG. 1, the Rye based on the signature of the genes identified in Table 1 and Table 2 allows predicting the absence of metastatic events at 5 years with a success rate of 100% (100% sensitivity) in a group of tumors (referred to hereinafter as the good prognosis group), and the presence of metastasis with a success rate of 40.1% (40.1% specificity) in the remaining tumors (referred to as the poor prognosis group).

A detailed analysis of the characteristics of the Desmedt tumors showed that those which were grade 3 ER− (46 samples) were not correctly predicted (data not shown). ROC curves of the remaining tumors showed that the signature of genes of the invention maintained sensitivity values of 100%, but it substantially improved the specificity up to 51.6% (FIG. 1, Table 7).

TABLE 7
Parameters of the analysis of ROC curves

| | | Desmedt dataset | |
|---|---|---|---|
| | | (142 tumors) | |
| DM at 5 | AUC | 0.846 | |
| years | RV | −39.2 | |
| | Threshold | | |
| | | Sensitivity | Specificity |
| | | 100.0 | 51.6 |
| DM at 10 | AUC | 0.819 | |
| years | RV | −39.2 | |
| | Threshold | | |
| | | Sensitivity | Specificity |
| | | 96.0 | 53.0 |

AUC = Area under the ROC curve

The results obtained demonstrate that the genetic signature of the invention could be used as an optimal predictor of DM at 5 years in human breast cancer.

Thus, from the formula hereinbefore described, the inventors have been able to determine whether a patient would belong to the good prognosis group or to the poor prognosis group. This method is based on the formula for calculating the risk value (RV) and on the ROC curve of DM at 5 years of the of Desmedt tumor group of 142 samples (FIG. 1, panel C). According to the ROC curves, the predictor would have a sensitivity of 100 and maximum specificity (RV=−39,2).

$$Si {\sum }_{i = 1}^{40} {s}_{i} \cdot {x}_{i} + 39.2 > 0 \to Poor prognosis$$

$$Si {\sum }_{i = 1}^{40} {s}_{i} \cdot {x}_{i} + 39.2 < 0 \to Good prognosis$$

### EXAMPLE 3

### Validation of the Predictor in an External Tumor Group

The Loi tumor group or Loi dataset was used as an external tumor group for validation or testing dataset. The Loi dataset contains: i) tumors from patients treated or not treated with tamoxifen; ii) tumors from patients who had lymph node metastasis (N+) or not (N−) at the time of the operation; and iii) ER− or ER+ tumors. The Loi tumor group contains a more varied range of breast cancer samples than the Desmedt dataset (only N−, and not treated with tamoxifen). The Loi dataset originally has 327 samples analyzed using both the Affymetrix U133A GeneChip and the U133B GeneChip. It also contains 87 tumors analyzed with the U133Plus 2.0 chip. Since the genomic signature for prediction contains probes (Table 6) which are within the U133A GeneChip and not the U133B GeneChip, the analyses performed with the U133B GeneChip were discarded. However, the 87 samples analyzed with the U133Plus 2.0 chip will be processed because this chip contains all the U133A probes. After normalization with RMA, 400 tumors met the quality criteria hereinbefore explained (NUSE and RLE graphics).

The expression values were extracted in log₂ scale for the genes of the signature of all the tumors. The risk value (RV) was calculated according to the formula hereinbefore described, the expression values of the new tumors and the Wald statistic values computed in the Cox analysis of the Desmedt dataset (Table 6) being used. The tumors for which there are no data on hormone treatment, tumor grade, presence or absence of ER, presence or absence of distant metastasis with follow-up over time, or the lymph node status, were discarded (94 samples). Out of the remaining 306 tumors, those tumors for which the genomic predictor did not work in the Desmedt dataset, i.e., grade 3 ER− tumors (19 samples), were eliminated. In the remaining 287 tumors, the precision of the genomic predictor was analyzed by groups of patients with similar characteristics.

3.1. The Genetic Signature of the Invention is a Genomic Predictor of Distant Metastasis in Breast Cancer Patients with Healthy Lymph Nodes and Who Did Not Receive Hormone Therapy.

First the tumors with characteristics similar to those of the tumors of the Desmedt study, i.e., patients not treated with tamoxifen, N− nodes, and tumor diameter ≦5 cm, were analyzed but this analysis was independent of the age of the patient (86 samples, see Table 8 with clinical characteristics).

TABLE 8
Clinical and pathological characteristics of the
patients of the Loi dataset

| | Loi Dataset | | | |
|---|---|---|---|---|
| | N− | | | |
| | No TM | | N+ | |
| | (n = 86) | | TM (n = 108) | |
| Age (years) | | | | |
| Mean | 52 | years | 64 | years |
| <45 | 19 | (22%) | 1 | (1%) |
| 45-65 | 65 | (76%) | 62 | (57%) |
| >65 | 2 | (2%) | 45 | (42%) |
| Size (cm) | | | | |
| <1 | 3 | (4%) | 1 | (1%) |
| 1-2 | 51 | (59%) | 35 | (32%) |
| >2-5 | 32 | (37%) | 72 | (67%) |
| Degree of tumor | | | | |
| differentiation | | | | |
| Poor | 12 | (14%) | 20 | (19%) |
| Moderate | 47 | (55%) | 65 | (60%) |
| Good | 27 | (31%) | 23 | (21%) |
| Unknown | | | | |
| ER status | | | | |
| Positive | 69 | (80%) | 107 | (99%) |
| Negative | 17 | (20%) | 1 | (1%) |
| Distant metastasis | | | | |
| after 5 years | | | | |
| Yes | 15 | (18%) | 23 | (21%) |
| No | 57 | (66%) | 71 | (66%) |
| Censored | 14 | (16%) | 14 | (13%) |

The data are numbers of patients, or percentages of patients.
TM = tamoxifen

Based on the computation of the genomic risk according to the rules of the formulas for a good or poor prognosis hereinbefore described, the signature of genes of the invention is a good predictor of DM at 5 and at 10 years. To that end, the relative risk (RR) between the patients with a good prognosis profile and the patients with a poor prognosis profile was calculated by means of a Cox proportional hazards analysis (Table 9).

TABLE 9
Univariate and multivariate Cox proportional hazards analysis in Loi dataset

| | | Dataset Loi | | | Dataset Loi | | |
|---|---|---|---|---|---|---|---|
| | | (86 tumors) ^{1, 3} | | | (108 tumors) ^{2,} ³ | | |
| | | RR ⁴ | CI 95% ⁴ | P ⁴ | RR ⁴ | CI 95% ⁴ | P ⁴ |
| DM | Univariate | 19.9 | 2.6 to 154.4 | 4.0E−03 | 4.2 | 1.2 to 14.6 | 2.1E−02 |
| at 5 | analysis | | | | | | |
| years | Multivariate | 14.9 | 1.8 to 123.7 | 1.2E−02 | 3.9 | 1.1 to 14.7 | 4.2E−02 |
| | analysis | | | | | | |
| DM | Univariate | 8.2 | 2.3 to 28.7 | 1.0E−03 | 4.7 | 1.6 to 13.5 | 4.5E−03 |
| at 10 | analysis | | | | | | |
| years | Multivariate | 7.3 | 1.9 to 28.5 | 4.0E−03 | 4.2 | 1.3 to 13 | 1.3E−02 |
| | analysis | | | | | | |

¹ Only tumors with diameter ≦5 cm, without adjuvant treatment, N−, ER+ (all grades) and ER− (grades 1 and 2)
² Only tumors with diameter ≦5 cm, with adjuvant treatment, N+
³ Stratified by hospital
⁴ RR = relative risk; CI = Confidence Interval; P = probability

According to Univariate analysis, the RR of developing DM between both patient groups is 19.9 at 5 years (confidence interval CI 95% 2.6-154.4, P=0.004) or 8.2 at 10 years (CI 95% 2.3-28.7, P=0.001). If the hazards analysis is multivariate, i.e., including the clinical data (age of the patient, tumor size, tumor grade, ER status) in the model, a RR of 14.9 at 5 years (CI 95% 1.8-123.7, P=0.012) and of 7.3 at 10 years (CI 95% 1.9-28.5, P=0,004) is obtained. It is important to point out that these RR are statistically significant in multivariate analysis, which demonstrates that the signature of the genes identified in Tables 1 and 2 is a genomic predictor independent of other clinical parameters (Table 9 and Table 10).

TABLE 10
Multivariate proportional hazards analysis, DM at 5 years in Loi dataset

| | N−, No Tamoxifen (n = 86) | | | N+, Tamoxifen (n = 108) | | |
|---|---|---|---|---|---|---|
| VARIABLE | RELATIVE RISK | CI* 95% | P VALUE | RELATIVE RISK | CI* 95% | P VALUE |
| Signature of poor | 14.9 | 1.8 to 123.7 | 0.012 | 3.9 | 1.1 to 14.6 | 0.042 |
| prognosis | | | | | | |
| (vs. good | | | | | | |
| prognosis) | | | | | | |
| Age (<45, 45 to | 1.3 | 0.4 to 3.6 | 0.678 | 4.7 | 0.5 to 44.4 | 0.173 |
| 65, >65) | | | | | | |
| Degree of tumor | 1.0 | 0.4 to 2.6 | 0.962 | 1.3 | 0.6 to 3.1 | 0.499 |
| differentiation | | | | | | |
| Tumor size (in cm) | 2.0 | 1.0 to 4.0 | 0.063 | 1.0 | 0.5 to 2.0 | 0.918 |
| ER status | 0.9 | 0.3 to 3.0 | 0.881 | 1.2 | 0.7 to 1.9 | 0.548 |

*CI denotes confidence interval

The probability of survival was also calculated in both patient groups (Table 11). Thus, the good prognosis group has a probability of survival at 5 years of 96.1% (±2.2), and 92.3% (±4.3) at 10 years. The poor prognosis group has a probability of 70.1% (±6.2) at 5 years and 49.2% (±8.7) at 10 years. The differences of survival between both groups are considerable, being 26% at 5 years and 43% at 10 years.

TABLE 11
Probabilities of survival of prognosis subgroups in Loi dataset

| | | Probability of | Probability |
|---|---|---|---|
| Dataset | Genomic group | DM at 5 years | DM at 10 years |
| Dataset Lai | Good prognosis | 96.1 ± 2.2 | 92.3 ± 4.3 |
| (86 tumors)¹ | Poor prognosis | 70.1 ± 6.2 | 49.2 ± 8.7 |
| Dataset Loi | Good prognosis | 94.2 ± 2.8 | 88.8 ± 5.3 |
| (108 tumors)² | Poor prognosis | 76.3 ± 4 | 58.2 ± 6.1 |

¹Only tumors with diameter ≦ 5 cm, without adjuvant treatment, N−, ER+ (all grades) and ER− (grades 1 and 2)
²Only tumors diameter ≦ 5 cm, with adjuvant treatment, N+

3.2. The Genetic Signature of the Invention is a Genomic Predictor of Distant Metastasis in Breast Cancer Patients with Lymph Node Metastasis and Who Received Hormone Therapy with Tamoxifen.

Then it was checked whether the predictive signature of the invention was valid for patients who, at the time of extracting the tumor, had lymph node metastasis (N+), and received hormone therapy, with a tumor diameter of ≦5 cm, but independently of the age of the patient (108 samples, see Table 8 with clinical characteristics). Similarly to what has been described in section 3.1, the patients were divided into two risk groups: poor prognosis and good prognosis. Univariate and multivariate Cox analysis was performed to check the relative risks of developing DM at 5 or at 10 years between both groups (Tables 9 and 10). The results show that the RR is 4.2 at 5 years (CI 95% 1.2-14.6, P=0.021), or 4.7 at 10 years (CI 95% 1.6-13.5, P=0.004) in Univariate analysis. When clinical parameters were included in the Cox model (age of the patient, tumor size, tumor grade), the genomic predictor proved to be independent of these parameters, maintaining the RR between the two prognosis groups, being 3.9 at 5 years (CI 95% 1.1-14.7, P=0.042) and 4.2 at 10 years (CI 95% 1.3-13, P=0.013) (Tables 9 and 10).

The probability of survival was also calculated in both patient groups (Table 11). Thus, the good prognosis group has a probability of survival at 5 years of 94.2% (±2.8) and 88.8% (±5.3) at 10 years. The poor prognosis group has a probability of 76.3% (±4) at 5 years and 58.2% (±6.1) at 10 years. The differences of survival between both groups are the 17.9% at 5 years and 30.6% at 10 years, which are also significant.

Finally, the prediction capacity of the genomic signature in the patient subgroup within the Loi study who, in the absence of local metastasis at the time of the extraction of the tumor, were treated with hormone therapy, with tumor diameter ≦5 cm, independently of the age of the patient (89 samples, all ER+) was analyzed. The results showed that despite the fact that the two groups defined by the genomic risk had a RR in Univariate analysis of about 2.5 at 5 years or 1.9 at 10 years, the differences were not statistically significant (data not shown).

Overall, the results show that the genetic signature of the invention is a good predictor of the risk of DM at 5 and 10 years in tumors smaller than 5 cm, ER+ tumors, ER− tumors (grade 1 and 2), in N− patients without hormone treatment, and in N+ patients treated with tamoxifen. Furthermore, in these patients the predictor is independent of the age of the patient, ER status, tumor grade, and tumor size.

### EXAMPLE 4

Comparison of the Genetic Signature of the Invention with Clinical Predictors

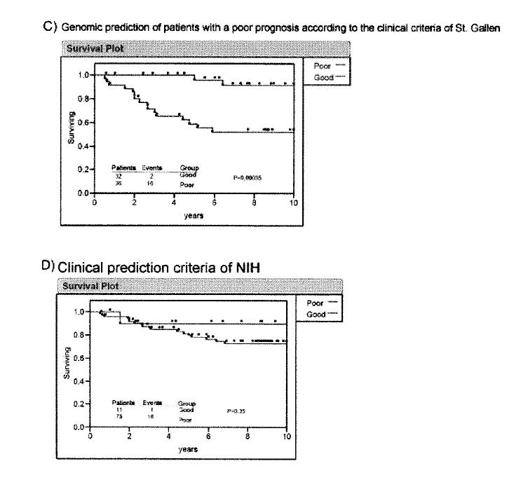

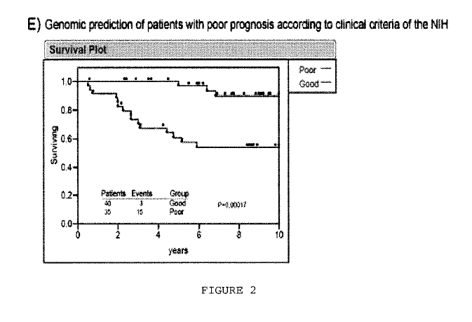

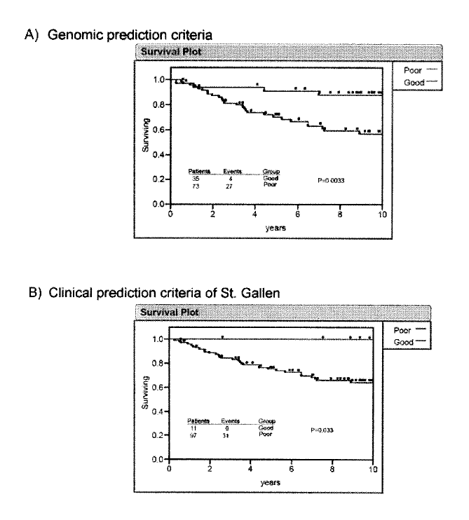

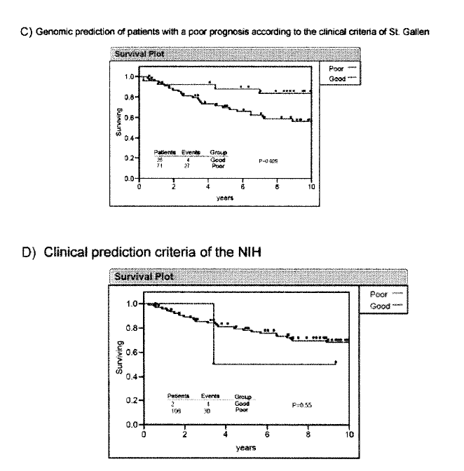

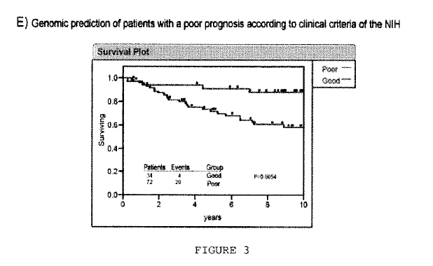

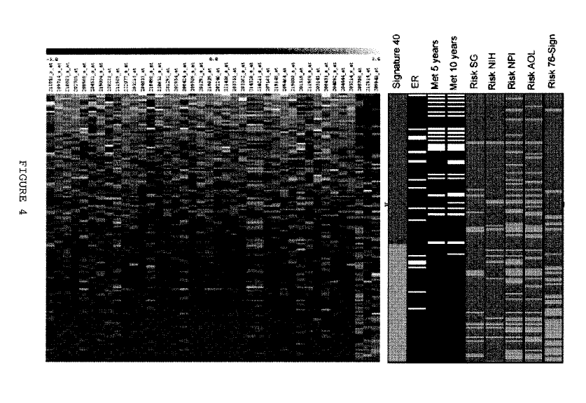

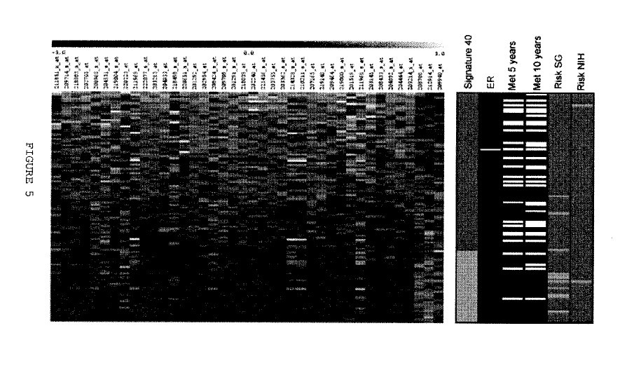

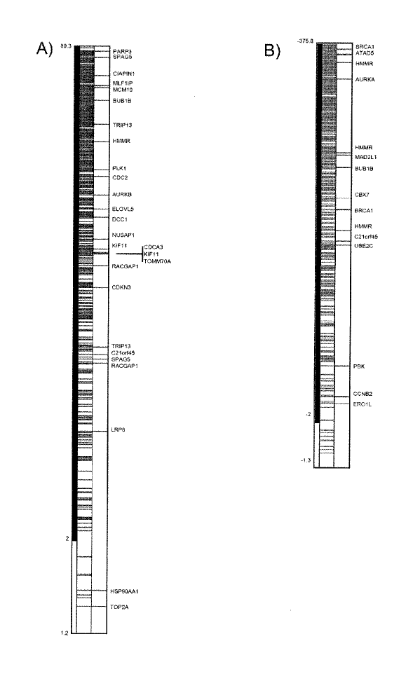

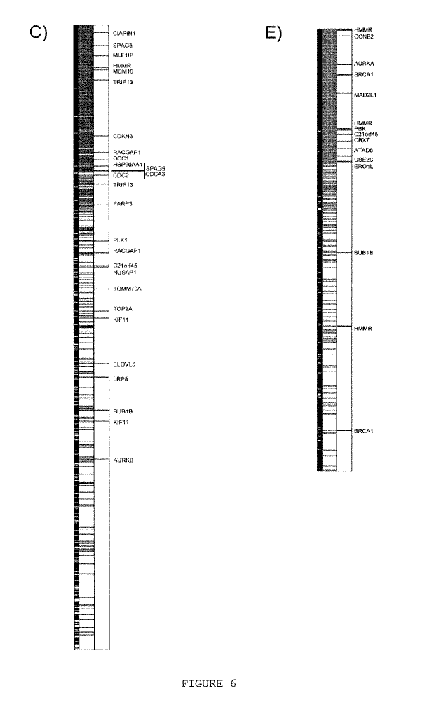

By means of Kaplan-Meier curves, survivals free of DM of the good or poor prognosis patient groups (FIG. 2, 86 N− patients and not treated with tamoxifen; FIG. 3, 108 N+ patients and treated with tamoxifen) were compared according to the criteria based on the genetic signature of the invention (FIGS. 2A and 3A), or according to the consensual clinical prediction criteria of St. Gallen (Goldhirsch A, at al. J Clin Oncol 2001; 19(18):3817-3827) (FIGS. 2B and 3B), or of the NIH (National Institutes of Health, USA) (Eifel P, at al. J Natl Cancer Inst 2001; 93(13):979-989) (FIGS. 2D and 3D) (see Table 12).

TABLE 12
Clinical criteria for receiving adjuvant chemotherapy

| | | |
|---|---|---|
| St. Gallen | tumor ≧ 2 cm | any of these criteria |
| | ER− | |
| | Grade 2 or 3 | |
| | patient < 35 | |
| | years | |
| NIH | tumor > 1 cm | |

The criteria of St. Gallen and of the NIH classify the patients as high risk or low risk based on several histological and clinical characteristics. This comparison shows that the prognostic signature of the invention assigns more patients to the low risk (or good prognosis) group than traditional methods do (56%, compared with 21% according to criteria of St. Gallen and 13% according to criteria of the NIH for patients not treated with tamoxifen and N−; 32%, compared with 10% according to criteria of St. Gallen and 2% according to criteria of the NIH for patients treated with tamoxifen and N+). The poor prognosis patients according to the genomic signature tend to have a higher proportion of DM than the poor prognosis patients according to the clinical criteria of St Gallen and NIH. This result indicates that both groups of clinical criteria used today mistakenly classify a clinically significant number of patients in the poor prognosis group. Furthermore, the poor prognosis group defined according to criteria of St. Gallen includes many patients who had a genomic signature of good prognosis and a good result (FIG. 2C and FIG. 3C). Similar subgroups were identified within the high risk group identified according to criteria of the NIH (FIG. 2E and FIG. 3E).

Given that both the St. Gallen and the NIH subgroups include patients that are poorly classified within the poor prognosis group among the patients not treated with tamoxifen and N−(subgroup of 86 patients), there would be patients that would be over-treated in current clinical practice. In addition, since all the N+ patients received hormone therapy (subgroup of 108 patients), it is not possible to determine how necessary genomic prediction would be in the absence of hormone treatment. However, the results show that the genetic signature of the invention is a good predictor of the response to treatment with tamoxifen in patients with lymph node metastasis.

1. An in vitro method for determining the prognosis of a subject diagnosed with breast cancer or for selecting the treatment of a subject diagnosed with breast cancer which comprises determining the expression levels of the genes identified in Table 1 and in Table 2 in a tumor tissue sample from said subject, wherein an increase of the expression of the genes identified in Table 1 and a decrease of the expression of the genes identified in Table 2 with respect to a reference value is indicative of a worse prognosis or of said subject having to be treated with chemotherapy.

2-11. (canceled)

12. A reagent capable of detecting the expression levels of the genes identified in Tables 1 and 2.

13-20. (canceled)

21. A method for selecting genetic markers for predicting the tendency to develop metastasis of a primary tumor comprising the following steps:
i) determining the genes the expression of which is altered with respect to a reference value in a tumor sample from a genetically modified non-human animal showing a tendency to develop tumors spontaneously;
ii) identifying the homologous genes in humans corresponding to the genes identified in step i); and
iii) selecting those genes identified in step ii) the expression of which in primary tumor samples from patients who develop metastasis from said primary tumor is altered with respect to the expression of said genes in primary tumors of patients who do not develop metastasis.

22-33. (canceled)

34. The method according to claim 1, wherein the determining of the expression levels of the genes identified in Tables 1 and 2 comprises the quantification of the messenger RNA (mRNA) of said genes, or a fragment of said mRNA, the complementary DNA (cDNA) of said genes, or a fragment of said cDNA, or mixtures thereof.

35. The method according to claim 1, wherein the determining of the expression levels of the genes identified in Tables 1 and 2 is performed by means of a quantitative multiplex polymerase chain reaction (PCR) or a DNA or RNA array.

36. The method according to claim 1, wherein the determining of the expression levels of the genes identified in Table 1 and Table 2 is performed by means of a DNA array comprising the probes identified in Tables 3 and 4.

37. The method according to claim 1, wherein the determination of said prognosis comprises a proportional hazards regression analysis of said prognosis depending on the expression levels of the genes identified in Table 1 and in Table 2.

38. The method according to claim 37, wherein said proportional hazards regression analysis is a Cox-type analysis.

39. The method according to claim 38, wherein distant metastasis is established in said Cox-type analysis as a prognostic variable.

40. The method according to claim 39, wherein said distant metastasis is distant metastasis at 5 or 10 years.

41. The method according to claim 38, wherein the determination of said prognosis is carried out by applying the following formula:
$${\sum }_{i = 1}^{40} {s}_{i} \cdot {x}_{i} + 39.2$$
wherein xᵢ is the value of the expression level in log2 of each of said genes identified in Tables 1 and 2; and
sᵢ is the value of the Wald statistic of the Cox-type regression analysis of each of said genes identified in Tables 1 and 2 according to claims 6 to 8,
wherein if said value is greater than zero, then it is indicative of said patient presenting a worse prognosis or of said patient having to be treated with chemotherapy, and wherein if said value is less than zero, it is indicative of said patient presenting a good prognosis or of said patient not having to be treated with chemotherapy.

42. The method according to claim 1, wherein the quantification of the expression levels of the genes identified in Tables 1 and 2 comprises the quantification of the levels of protein encoded by said genes or of a variant thereof.

43. The reagent according to claim 12, wherein the reagent comprises
(i) a set of nucleic acids comprising the nucleotide sequences of the probes identified in Tables 1 and 2 or the products of their transcription, or
(ii) a set of antibodies or a fragment thereof capable of detecting an antigen, consisting of each antibody or fragment being capable of binding specifically to one of the proteins encoded by the genes the nucleotide sequences of which hybridize with the probes identified in Tables 1 and 2.

44. The reagent according to claim 43, wherein the nucleic acids are DNA, cDNA or RNA probes and/or primers.

45. The method according to claim 21, wherein said non-human animal is an animal in which the gene expression of the Tp53 gene is inhibited.

46. The method according to claim 45, wherein said animal further presents inhibited gene expression of the pRb gene.

47. The method according to claim 21, wherein the sample obtained in step (i) is an epidermal carcinoma sample.

48. The method according to any of claim 21, wherein said step iii) is carried out by means of a proportional hazards regression analysis.

49. The method according to any of claim 21, wherein said primary tumors analyzed in step iii) are breast cancer or glioblastoma tumors.

50. The method according to any of claim 21, wherein the quantification of the expression levels of the genes according to step iii) comprises the quantification of the levels of protein encoded by said genes.


SEQUENCE LISTING (440 sequences)

SEQ ID NO: 1 - DNA, 25 bp, Artificial
  Probe 1 for determining the expression of the TOP2A gene
gagacttttttgaactcagacttaa

SEQ ID NO: 2 - DNA, 25 bp, Artificial
  Probe 2 for determining the expression of the TOP2A gene
tggctcctaggaatgcttggtgctg

SEQ ID NO: 3 - DNA, 25 bp, Artificial
  Probe 3 for determining the expression of the TOP2A gene
cttggtgctgaatctgctaaactga

SEQ ID NO: 4 - DNA, 25 bp, Artificial
  Probe 4 for determining the expression of the TOP2A gene
gaataatcaggctcgctttatctta

SEQ ID NO: 5 - DNA, 25 bp, Artificial
  Probe 5 for determining the expression of the TOP2A gene
gatatgattcggatcctgtgaaggc

SEQ ID NO: 6 - DNA, 25 bp, Artificial
  Probe 6 for determining the expression of the TOP2A gene
actccgtaacagattctggaccaac

SEQ ID NO: 7 - DNA, 25 bp, Artificial
  Probe 7 for determining the expression of the TOP2A gene
gaccaaccttcaactatcttcttga

SEQ ID NO: 8 - DNA, 25 bp, Artificial
  Probe 8 for determining the expression of the TOP2A gene
gaaagatgaactctgcaggctaaga

SEQ ID NO: 9 - DNA, 25 bp, Artificial
  Probe 9 for determining the expression of the TOP2A gene
aagaacaagagctggacacattaaa

SEQ ID NO: 10 - DNA, 25 bp, Artificial
  Probe 10 for determining the expression of the TOP2A gene
aaagaaagagtccatcagatttgtg

SEQ ID NO: 11 - DNA, 25 bp, Artificial
  Probe 11 for determining the expression of the TOP2A gene
acaagatgaacaagtcggacttcct

SEQ ID NO: 12 - DNA, 25 bp, Artificial
  Probe 1 for determining the expression of the TOP2A-2 gene
tacagatactctactacactcagcc

SEQ ID NO: 13 - DNA, 25 bp, Artificial
  Probe 2 for determining the expression of the TOP2A-2 gene
ctactacactcagcctcttatgtgc

SEQ ID NO: 14 - DNA, 25 bp, Artificial
  Probe 3 for determining the expression of the TOP2A-2 gene
gcctcttatgtgccaagtttttctt

SEQ ID NO: 15 - DNA, 25 bp, Artificial
  Probe 4 for determining the expression of the TOP2A-2 gene
tcatcttctcaaatcatcagaggcc

SEQ ID NO: 16 - DNA, 25 bp, Artificial
  Probe 5 for determining the expression of the TOP2A-2 gene
actttggctgtgtctataacttgac

SEQ ID NO: 17 - DNA, 25 bp, Artificial
  Probe 6 for determining the expression of the TOP2A-2 gene
agtagttatgtgattatttcagctc

SEQ ID NO: 18 - DNA, 25 bp, Artificial
  Probe 7 for determining the expression of the TOP2A-2 gene
actggattgcagaagactcggggac

SEQ ID NO: 19 - DNA, 25 bp, Artificial
  Probe 8 for determining the expression of the TOP2A-2 gene
gactcggggacaacatttgatccaa

SEQ ID NO: 20 - DNA, 25 bp, Artificial
  Probe 9 for determining the expression of the TOP2A-2 gene
ttatattgataaccatgctcagcaa

SEQ ID NO: 21 - DNA, 25 bp, Artificial
  Probe 10 for determining the expression of the TOP2A-2 gene
attcattttgggaaatctccataat

SEQ ID NO: 22 - DNA, 25 bp, Artificial
  Probe 11 for determining the expression of the TOP2A-2 gene
taagacctgtctacattgttatatg

SEQ ID NO: 23 - DNA, 25 bp, Artificial
  Probe 1 for determining the expression of the TOMM70A gene
taagggtgcttaattctgttgaaac

SEQ ID NO: 24 - DNA, 25 bp, Artificial
  Probe 2 for determining the expression of the TOMM70A gene
ttgtctacaaatgctatctttttta

SEQ ID NO: 25 - DNA, 25 bp, Artificial
  Probe 3 for determining the expression of the TOMM70A gene
ggaagtttgagaccgctgcattttg

SEQ ID NO: 26 - DNA, 25 bp, Artificial
  Probe 4 for determining the expression of the TOMM70A gene
aaattatgcaccttctgataacccc

SEQ ID NO: 27 - DNA, 25 bp, Artificial
  Probe 5 for determining the expression of the TOMM70A gene
aatgttctacatctctgaatgacct

SEQ ID NO: 28 - DNA, 25 bp, Artificial
  Probe 6 for determining the expression of the TOMM70A gene
tctctgaatgacctctgactttaaa

SEQ ID NO: 29 - DNA, 25 bp, Artificial
  Probe 7 for determining the expression of the TOMM70A gene
tctcccttctttcatcttggggttg

SEQ ID NO: 30 - DNA, 25 bp, Artificial
  Probe 8 for determining the expression of the TOMM70A gene
gaagcatgtgccattctatactgtc

SEQ ID NO: 31 - DNA, 25 bp, Artificial
  Probe 9 for determining the expression of the TOMM70A gene
gtgccattctatactgtcattccaa

SEQ ID NO: 32 - DNA, 25 bp, Artificial
  Probe 10 for determining the expression of the TOMM70A gene
aattctcatggactattgcctgttg

SEQ ID NO: 33 - DNA, 25 bp, Artificial
  Probe 11 for determining the expression of the TOMM70A gene
ctgaaagctgcatctgtctgtatct

SEQ ID NO: 34 - DNA, 25 bp, Artificial
  Probe 1 for determining the expression of the PLK1 gene
acgccgcgcgaaggtgatgagctcg

SEQ ID NO: 35 - DNA, 25 bp, Artificial
  Probe 2 for determining the expression of the PLK1 gene
acctcagcaacggcagcgtgcagat

SEQ ID NO: 36 - DNA, 25 bp, Artificial
  Probe 3 for determining the expression of the PLK1 gene
atcaacttcttccaggatcacacca

SEQ ID NO: 37 - DNA, 25 bp, Artificial
  Probe 4 for determining the expression of the PLK1 gene
gatcacaccaagctcatcttgtgcc

SEQ ID NO: 38 - DNA, 25 bp, Artificial
  Probe 5 for determining the expression of the PLK1 gene
cactgatggcagccgtgacctacat

SEQ ID NO: 39 - DNA, 25 bp, Artificial
  Probe 6 for determining the expression of the PLK1 gene
gagaagcgggacttccgcacatacc

SEQ ID NO: 40 - DNA, 25 bp, Artificial
  Probe 7 for determining the expression of the PLK1 gene
accgcctgagtctcctggaggagta

SEQ ID NO: 41 - DNA, 25 bp, Artificial
  Probe 8 for determining the expression of the PLK1 gene
tacgcccgcactatggtggacaagc

SEQ ID NO: 42 - DNA, 25 bp, Artificial
  Probe 9 for determining the expression of the PLK1 gene
gtctcaaggcctcctaatagctgcc

SEQ ID NO: 43 - DNA, 25 bp, Artificial
  Probe 10 for determining the expression of the PLK1 gene
gtggctgggcagagctgcatcatcc

SEQ ID NO: 44 - DNA, 25 bp, Artificial
  Probe 11 for determining the expression of the PLK1 gene
gtgtgggttctacagacttgtcccc

SEQ ID NO: 45 - DNA, 25 bp, Artificial
  Probe 1 for determining the expression of the CCNB2 gene
gccactacacttcttaaggcgagca

SEQ ID NO: 46 - DNA, 25 bp, Artificial
  Probe 2 for determining the expression of the CCNB2 gene
gcgagcatcaaaagccggggaggtt

SEQ ID NO: 47 - DNA, 25 bp, Artificial
  Probe 3 for determining the expression of the CCNB2 gene
atggagctgactctcatcgactatg

SEQ ID NO: 48 - DNA, 25 bp, Artificial
  Probe 4 for determining the expression of the CCNB2 gene
atatggtgcattatcatccttctaa

SEQ ID NO: 49 - DNA, 25 bp, Artificial
  Probe 5 for determining the expression of the CCNB2 gene
atccttctaaggtagcagcagctgc

SEQ ID NO: 50 - DNA, 25 bp, Artificial
  Probe 6 for determining the expression of the CCNB2 gene
acttaactaaattcatcgccatcaa

SEQ ID NO: 51 - DNA, 25 bp, Artificial
  Probe 7 for determining the expression of the CCNB2 gene
caaaagccgtcaaagaccttgcctc

SEQ ID NO: 52 - DNA, 25 bp, Artificial
  Probe 8 for determining the expression of the CCNB2 gene
cttgcctccccactgataggaaggt

SEQ ID NO: 53 - DNA, 25 bp, Artificial
  Probe 9 for determining the expression of the CCNB2 gene
gataggaaggtcctaggctgccgtg

SEQ ID NO: 54 - DNA, 25 bp, Artificial
  Probe 10 for determining the expression of the CCNB2 gene
gattttgtacatagtcctctggtct

SEQ ID NO: 55 - DNA, 25 bp, Artificial
  Probe 11 for determining the expression of the CCNB2 gene
agtcctctggtctatctcatgaaac

SEQ ID NO: 56 - DNA, 25 bp, Artificial
  Probe 1 for determining the expression of the UBEC2C gene
gccttccctgaatcagacaaccttt

SEQ ID NO: 57 - DNA, 25 bp, Artificial
  Probe 2 for determining the expression of the UBEC2C gene
gggtagggaccatccatggagcagc

SEQ ID NO: 58 - DNA, 25 bp, Artificial
  Probe 3 for determining the expression of the UBEC2C gene
tataagctctcgctagagttcccca

SEQ ID NO: 59 - DNA, 25 bp, Artificial
  Probe 4 for determining the expression of the UBEC2C gene
caatgcgcccacagtgaagttcctc

SEQ ID NO: 60 - DNA, 25 bp, Artificial
  Probe 5 for determining the expression of the UBEC2C gene
gggtaacatatgcctggacatcctg

SEQ ID NO: 61 - DNA, 25 bp, Artificial
  Probe 6 for determining the expression of the UBEC2C gene
ggaaaagtggtctgccctgtatgat

SEQ ID NO: 62 - DNA, 25 bp, Artificial
  Probe 7 for determining the expression of the UBEC2C gene
atgatgtcaggaccattctgctctc

SEQ ID NO: 63 - DNA, 25 bp, Artificial
  Probe 8 for determining the expression of the UBEC2C gene
tccatccagagccttctaggagaac

SEQ ID NO: 64 - DNA, 25 bp, Artificial
  Probe 9 for determining the expression of the UBEC2C gene
tgatagtcccttgaacacacatgct

SEQ ID NO: 65 - DNA, 25 bp, Artificial
  Probe 10 for determining the expression of the UBEC2C gene
gagctctggaaaaaccccacagctt

SEQ ID NO: 66 - DNA, 25 bp, Artificial
  Probe 11 for determining the expression of the UBEC2C gene
agatggtctgtcctttttgtgattt

SEQ ID NO: 67 - DNA, 25 bp, Artificial
  Probe 1 for determining the expression of the SPAG5 gene
gagtggcgagctcataagccttaga

SEQ ID NO: 68 - DNA, 25 bp, Artificial
  Probe 2 for determining the expression of the SPAG5 gene
tagagaggaggtgacccaccttacc

SEQ ID NO: 69 - DNA, 25 bp, Artificial
  Probe 3 for determining the expression of the SPAG5 gene
ctcacttcggcgtgcggagacagag

SEQ ID NO: 70 - DNA, 25 bp, Artificial
  Probe 4 for determining the expression of the SPAG5 gene
agagaccaaagtgctccaggaggcc

SEQ ID NO: 71 - DNA, 25 bp, Artificial
  Probe 5 for determining the expression of the SPAG5 gene
gcctatggccaccaattggatccag

SEQ ID NO: 72 - DNA, 25 bp, Artificial
  Probe 6 for determining the expression of the SPAG5 gene
tcctagaggagaaccttcggcgctc

SEQ ID NO: 73 - DNA, 25 bp, Artificial
  Probe 7 for determining the expression of the SPAG5 gene
aaccttcggcgctctgacaaggagt

SEQ ID NO: 74 - DNA, 25 bp, Artificial
  Probe 8 for determining the expression of the SPAG5 gene
atttataagaccctgctctctattc

SEQ ID NO: 75 - DNA, 25 bp, Artificial
  Probe 9 for determining the expression of the SPAG5 gene
ccctgctctctattccagaggtggt

SEQ ID NO: 76 - DNA, 25 bp, Artificial
  Probe 10 for determining the expression of the SPAG5 gene
gaaagccagaatttgtttcacctct

SEQ ID NO: 77 - DNA, 25 bp, Artificial
  Probe 11 for determining the expression of the SPAG5 gene
taccccaataccaagaccaactggc

SEQ ID NO: 78 - DNA, 25 bp, Artificial
  Probe 1 for determining the expression of the CDC2 gene
tgctaagttcaagtttcgtaatgct

SEQ ID NO: 79 - DNA, 25 bp, Artificial
  Probe 2 for determining the expression of the CDC2 gene
tgaagtatttttatgctctgaatgt

SEQ ID NO: 80 - DNA, 25 bp, Artificial
  Probe 3 for determining the expression of the CDC2 gene
aaatgttctcatcagtttcttgcca

SEQ ID NO: 81 - DNA, 25 bp, Artificial
  Probe 4 for determining the expression of the CDC2 gene
tgttaactatacaacctggctaaag

SEQ ID NO: 82 - DNA, 25 bp, Artificial
  Probe 5 for determining the expression of the CDC2 gene
gatgaatatttttctactggtattt

SEQ ID NO: 83 - DNA, 25 bp, Artificial
  Probe 6 for determining the expression of the CDC2 gene
caaagatcaagggctgtccgcaaca

SEQ ID NO: 84 - DNA, 25 bp, Artificial
  Probe 7 for determining the expression of the CDC2 gene
aagggctgtccgcaacagggaagaa

SEQ ID NO: 85 - DNA, 25 bp, Artificial
  Probe 8 for determining the expression of the CDC2 gene
gaaagctttttgtctaagtgaattc

SEQ ID NO: 86 - DNA, 25 bp, Artificial
  Probe 9 for determining the expression of the CDC2 gene
gtgaattcttatgccttggtcagag

SEQ ID NO: 87 - DNA, 25 bp, Artificial
  Probe 10 for determining the expression of the CDC2 gene
cttatcttggctttcgagtctgagt

SEQ ID NO: 88 - DNA, 25 bp, Artificial
  Probe 11 for determining the expression of the CDC2 gene
gacatagtgtttattagcagccatc

SEQ ID NO: 89 - DNA, 25 bp, Artificial
  Probe 1 for determining the expression of the CDC2-2 gene
ggggattgtgttttgtcactctaga

SEQ ID NO: 90 - DNA, 25 bp, Artificial
  Probe 2 for determining the expression of the CDC2-2 gene
taaactggctgattttggccttgcc

SEQ ID NO: 91 - DNA, 25 bp, Artificial
  Probe 3 for determining the expression of the CDC2-2 gene
ttggccttgccagagcttttggaat

SEQ ID NO: 92 - DNA, 25 bp, Artificial
  Probe 4 for determining the expression of the CDC2-2 gene
gtaacactctggtacagatctccag

SEQ ID NO: 93 - DNA, 25 bp, Artificial
  Probe 5 for determining the expression of the CDC2-2 gene
gtattgctggggtcagctcgttact

SEQ ID NO: 94 - DNA, 25 bp, Artificial
  Probe 6 for determining the expression of the CDC2-2 gene
agctcgttactcaactccagttgac

SEQ ID NO: 95 - DNA, 25 bp, Artificial
  Probe 7 for determining the expression of the CDC2-2 gene
taggcaccatatttgctgaactagc

SEQ ID NO: 96 - DNA, 25 bp, Artificial
  Probe 8 for determining the expression of the CDC2-2 gene
gaaaccacttttccatggggattca

SEQ ID NO: 97 - DNA, 25 bp, Artificial
  Probe 9 for determining the expression of the CDC2-2 gene
gattttcagagctttgggcactccc

SEQ ID NO: 98 - DNA, 25 bp, Artificial
  Probe 10 for determining the expression of the CDC2-2 gene
aaaccaggaagcctagcatcccatg

SEQ ID NO: 99 - DNA, 25 bp, Artificial
  Probe 11 for determining the expression of the CDC2-2 gene
aatggcttggatttgctctcgaaaa

SEQ ID NO: 100 - DNA, 25 bp, Artificial
  Probe 1 for determining the expression of the MAD2L1 gene
aaatgatacttactgaactgtgtgt

SEQ ID NO: 101 - DNA, 25 bp, Artificial
  Probe 2 for determining the expression of the MAD2L1 gene
gtacctatttgacttaccatggagt

SEQ ID NO: 102 - DNA, 25 bp, Artificial
  Probe 3 for determining the expression of the MAD2L1 gene
ggaggtttttttgtcaacattgtga

SEQ ID NO: 103 - DNA, 25 bp, Artificial
  Probe 4 for determining the expression of the MAD2L1 gene
aagctagatgctttcctaaatcaga

SEQ ID NO: 104 - DNA, 25 bp, Artificial
  Probe 5 for determining the expression of the MAD2L1 gene
cagaatctttgttaaggtcctgaaa

SEQ ID NO: 105 - DNA, 25 bp, Artificial
  Probe 6 for determining the expression of the MAD2L1 gene
aggtcctgaaagtaactcataatct

SEQ ID NO: 106 - DNA, 25 bp, Artificial
  Probe 7 for determining the expression of the MAD2L1 gene
attgctgtatagctccttttgacct

SEQ ID NO: 107 - DNA, 25 bp, Artificial
  Probe 8 for determining the expression of the MAD2L1 gene
ctccttttgaccttcatttcatgta

SEQ ID NO: 108 - DNA, 25 bp, Artificial
  Probe 9 for determining the expression of the MAD2L1 gene
atttcatgtatagttttccctattg

SEQ ID NO: 109 - DNA, 25 bp, Artificial
  Probe 10 for determining the expression of the MAD2L1 gene
gttttccctattgaatcagtttcca

SEQ ID NO: 110 - DNA, 25 bp, Artificial
  Probe 11 for determining the expression of the MAD2L1 gene
atttgtactgtttaatgttctgtga

SEQ ID NO: 111 - DNA, 25 bp, Artificial
  Probe 1 for determining the expression of the BUB1B gene
ttctttgtgcggattctgaatgcca

SEQ ID NO: 112 - DNA, 25 bp, Artificial
  Probe 2 for determining the expression of the BUB1B gene
tggggtttttgacactacattccaa

SEQ ID NO: 113 - DNA, 25 bp, Artificial
  Probe 3 for determining the expression of the BUB1B gene
gttaactagtcctggggctttgctc

SEQ ID NO: 114 - DNA, 25 bp, Artificial
  Probe 4 for determining the expression of the BUB1B gene
ggggctttgctctttcagtgagcta

SEQ ID NO: 115 - DNA, 25 bp, Artificial
  Probe 5 for determining the expression of the BUB1B gene
gagctaggcaatcaagtctcacaga

SEQ ID NO: 116 - DNA, 25 bp, Artificial
  Probe 6 for determining the expression of the BUB1B gene
gtctcacagattgctgcctcagagc

SEQ ID NO: 117 - DNA, 25 bp, Artificial
  Probe 7 for determining the expression of the BUB1B gene
ggacacatttagatgcactaccatt

SEQ ID NO: 118 - DNA, 25 bp, Artificial
  Probe 8 for determining the expression of the BUB1B gene
cactaccattgctgttctacttttt

SEQ ID NO: 119 - DNA, 25 bp, Artificial
  Probe 9 for determining the expression of the BUB1B gene
ggtacaggtatattttgacgtcact

SEQ ID NO: 120 - DNA, 25 bp, Artificial
  Probe 10 for determining the expression of the BUB1B gene
ggccttgtctaacttttgtgaagaa

SEQ ID NO: 121 - DNA, 25 bp, Artificial
  Probe 11 for determining the expression of the BUB1B gene
gttctcttatgatcaccatgtattt

SEQ ID NO: 122 - DNA, 25 bp, Artificial
  Probe 1 for determining the expression of the TRIP13 gene
gaagaaccatcgaaacctgtttgtt

SEQ ID NO: 123 - DNA, 25 bp, Artificial
  Probe 2 for determining the expression of the TRIP13 gene
aaatgcacacattactccaggtgga

SEQ ID NO: 124 - DNA, 25 bp, Artificial
  Probe 3 for determining the expression of the TRIP13 gene
ggtggcaattgctttctgatatcag

SEQ ID NO: 125 - DNA, 25 bp, Artificial
  Probe 4 for determining the expression of the TRIP13 gene
atcaagacatggtcccatttgcagg

SEQ ID NO: 126 - DNA, 25 bp, Artificial
  Probe 5 for determining the expression of the TRIP13 gene
gtgcagactctgagtgttccaggga

SEQ ID NO: 127 - DNA, 25 bp, Artificial
  Probe 6 for determining the expression of the TRIP13 gene
gaaacacatgctggacatcccttgt

SEQ ID NO: 128 - DNA, 25 bp, Artificial
  Probe 7 for determining the expression of the TRIP13 gene
catcccttgtaacccggtatgggcg

SEQ ID NO: 129 - DNA, 25 bp, Artificial
  Probe 8 for determining the expression of the TRIP13 gene
ctgcattgctgggatgtttctgccc

SEQ ID NO: 130 - DNA, 25 bp, Artificial
  Probe 9 for determining the expression of the TRIP13 gene
ctgcccacggttttgtttgtgcaat

SEQ ID NO: 131 - DNA, 25 bp, Artificial
  Probe 10 for determining the expression of the TRIP13 gene
ataggtcagttactggtctctttct

SEQ ID NO: 132 - DNA, 25 bp, Artificial
  Probe 11 for determining the expression of the TRIP13 gene
ggtctctttctgccgaatgttatgt

SEQ ID NO: 133 - DNA, 25 bp, Artificial
  Probe 1 for determining the expression of the AURKA gene
tgccctgaccccgatcagttaagga

SEQ ID NO: 134 - DNA, 25 bp, Artificial
  Probe 2 for determining the expression of the AURKA gene
gaccccgatcagttaaggagctgtg

SEQ ID NO: 135 - DNA, 25 bp, Artificial
  Probe 3 for determining the expression of the AURKA gene
gagctgtgcaataaccttcctagta

SEQ ID NO: 136 - DNA, 25 bp, Artificial
  Probe 4 for determining the expression of the AURKA gene
gctgtgcaataaccttcctagtacc

SEQ ID NO: 137 - DNA, 25 bp, Artificial
  Probe 5 for determining the expression of the AURKA gene
aaagctgttggaatgagtatgtgat

SEQ ID NO: 138 - DNA, 25 bp, Artificial
  Probe 6 for determining the expression of the AURKA gene
ttgtattttttctctggtggcattc

SEQ ID NO: 139 - DNA, 25 bp, Artificial
  Probe 7 for determining the expression of the AURKA gene
ttttttctctggtggcattccttta

SEQ ID NO: 140 - DNA, 25 bp, Artificial
  Probe 8 for determining the expression of the AURKA gene
ttctctggtggcattcctttaggaa

SEQ ID NO: 141 - DNA, 25 bp, Artificial
  Probe 9 for determining the expression of the AURKA gene
attcctttaggaatgctgtgtgtct

SEQ ID NO: 142 - DNA, 25 bp, Artificial
  Probe 10 for determining the expression of the AURKA gene
ttaaccacttatctcccatatgaga

SEQ ID NO: 143 - DNA, 25 bp, Artificial
  Probe 11 for determining the expression of the AURKA gene
cacttatctcccatatgagagtgtg

SEQ ID NO: 144 - DNA, 25 bp, Artificial
  Probe 1 for determining the expression of the KIF11 gene
aagcccactttagagtatacattgc

SEQ ID NO: 145 - DNA, 25 bp, Artificial
  Probe 2 for determining the expression of the KIF11 gene
acattgctattatgggagaccaccc

SEQ ID NO: 146 - DNA, 25 bp, Artificial
  Probe 3 for determining the expression of the KIF11 gene
acccagacatctgactaatggctct

SEQ ID NO: 147 - DNA, 25 bp, Artificial
  Probe 4 for determining the expression of the KIF11 gene
tgactaatggctctgtgccacactc

SEQ ID NO: 148 - DNA, 25 bp, Artificial
  Probe 5 for determining the expression of the KIF11 gene
actccaagacctgtgccttttagag

SEQ ID NO: 149 - DNA, 25 bp, Artificial
  Probe 6 for determining the expression of the KIF11 gene
gtatctttttctcgattcaaatctt

SEQ ID NO: 150 - DNA, 25 bp, Artificial
  Probe 7 for determining the expression of the KIF11 gene
ttcaaatcttaacccttaggactct

SEQ ID NO: 151 - DNA, 25 bp, Artificial
  Probe 8 for determining the expression of the KIF11 gene
aggactctggtatttttgatctggc

SEQ ID NO: 152 - DNA, 25 bp, Artificial
  Probe 9 for determining the expression of the KIF11 gene
ttttgatctggcaaccatatttctg

SEQ ID NO: 153 - DNA, 25 bp, Artificial
  Probe 10 for determining the expression of the KIF11 gene
gaataaattttctgctcacgatgag

SEQ ID NO: 154 - DNA, 25 bp, Artificial
  Probe 11 for determining the expression of the KIF11 gene
gagacatctgactttgatagctaaa

SEQ ID NO: 155 - DNA, 25 bp, Artificial
  Probe 1 for determining the expression of the BRCA1 gene
ttcaagaaccggtttccaaagacag

SEQ ID NO: 156 - DNA, 25 bp, Artificial
  Probe 2 for determining the expression of the BRCA1 gene
atgtttattgttgtagctctggtat

SEQ ID NO: 157 - DNA, 25 bp, Artificial
  Probe 3 for determining the expression of the BRCA1 gene
gctctggtatataatccattcctct

SEQ ID NO: 158 - DNA, 25 bp, Artificial
  Probe 4 for determining the expression of the BRCA1 gene
taagacctctggcatgaatatttca

SEQ ID NO: 159 - DNA, 25 bp, Artificial
  Probe 5 for determining the expression of the BRCA1 gene
tgacagatcccaccaggaaggaagc

SEQ ID NO: 160 - DNA, 25 bp, Artificial
  Probe 6 for determining the expression of the BRCA1 gene
tgctccctgttgctgaaaccataca

SEQ ID NO: 161 - DNA, 25 bp, Artificial
  Probe 7 for determining the expression of the BRCA1 gene
aaaccatacagcttcataaataatt

SEQ ID NO: 162 - DNA, 25 bp, Artificial
  Probe 8 for determining the expression of the BRCA1 gene
cataaacccattatccaggactgtt

SEQ ID NO: 163 - DNA, 25 bp, Artificial
  Probe 9 for determining the expression of the BRCA1 gene
aggactgtttatagctgttggaagg

SEQ ID NO: 164 - DNA, 25 bp, Artificial
  Probe 10 for determining the expression of the BRCA1 gene
tggaaggactaggtcttccctagcc

SEQ ID NO: 165 - DNA, 25 bp, Artificial
  Probe 11 for determining the expression of the BRCA1 gene
agggcagtgaagacttgattgtaca

SEQ ID NO: 166 - DNA, 25 bp, Artificial
  Probe 1 for determining the expression of the HMMR
atttacaggttcttaggctccatcc

SEQ ID NO: 167 - DNA, 25 bp, Artificial
  Probe 2 for determining the expression of the HMMR
aggctccatcctgtttgtatgaaat

SEQ ID NO: 168 - DNA, 25 bp, Artificial
  Probe 3 for determining the expression of the HMMR
taatctgtggattggcctttaagcc

SEQ ID NO: 169 - DNA, 25 bp, Artificial
  Probe 4 for determining the expression of the HMMR
gattggcctttaagcctgcattctt

SEQ ID NO: 170 - DNA, 25 bp, Artificial
  Probe 5 for determining the expression of the HMMR
gcctgcattcttaacaaactcttca

SEQ ID NO: 171 - DNA, 25 bp, Artificial
  Probe 6 for determining the expression of the HMMR
actctacatgtaactatttcttcag

SEQ ID NO: 172 - DNA, 25 bp, Artificial
  Probe 7 for determining the expression of the HMMR
actatttcttcagagtttgtcatat

SEQ ID NO: 173 - DNA, 25 bp, Artificial
  Probe 8 for determining the expression of the HMMR
gtttgtcatatactgcttgtcatct

SEQ ID NO: 174 - DNA, 25 bp, Artificial
  Probe 9 for determining the expression of the HMMR
ctgcttgtcatctgcatgtctactc

SEQ ID NO: 175 - DNA, 25 bp, Artificial
  Probe 10 for determining the expression of the HMMR
atctgcatgtctactcagcatttga

SEQ ID NO: 176 - DNA, 25 bp, Artificial
  Probe 11 for determining the expression of the HMMR
tcagcatttgattaacatttgtgta

SEQ ID NO: 177 - DNA, 25 bp, Artificial
  Probe 1 for determining the expression of the CIAPIN1
gctgcatatcttgacatatcttgag

SEQ ID NO: 178 - DNA, 25 bp, Artificial
  Probe 2 for determining the expression of the CIAPIN1
atcttgagattctgcatgtcttgta

SEQ ID NO: 179 - DNA, 25 bp, Artificial
  Probe 3 for determining the expression of the CIAPIN1
gatgttggatagtcatccacgctca

SEQ ID NO: 180 - DNA, 25 bp, Artificial
  Probe 4 for determining the expression of the CIAPIN1
catccacgctcagtttggaccattg

SEQ ID NO: 181 - DNA, 25 bp, Artificial
  Probe 5 for determining the expression of the CIAPIN1
ggaggaacttagtgtcacgcacaaa

SEQ ID NO: 182 - DNA, 25 bp, Artificial
  Probe 6 for determining the expression of the CIAPIN1
caaatggggctattcctacgcttag

SEQ ID NO: 183 - DNA, 25 bp, Artificial
  Probe 7 for determining the expression of the CIAPIN1
tagaatagggcttgtctgcccactt

SEQ ID NO: 184 - DNA, 25 bp, Artificial
  Probe 8 for determining the expression of the CIAPIN1
gtctgcccactttagaagagtccag

SEQ ID NO: 185 - DNA, 25 bp, Artificial
  Probe 9 for determining the expression of the CIAPIN1
gaacgacaatacgtctctctgagca

SEQ ID NO: 186 - DNA, 25 bp, Artificial
  Probe 10 for determining the expression of the CIAPIN1
gttcttgttatccacccatatggac

SEQ ID NO: 187 - DNA, 25 bp, Artificial
  Probe 11 for determining the expression of the CIAPIN1
tatggacttggaatcaatcttgcca

SEQ ID NO: 188 - DNA, 25 bp, Artificial
  Probe 1 for determining the expression of the LRP8
gaattttgacaacccagtctacagg

SEQ ID NO: 189 - DNA, 25 bp, Artificial
  Probe 2 for determining the expression of the LRP8
tgctcagattggccatgtctatcct

SEQ ID NO: 190 - DNA, 25 bp, Artificial
  Probe 3 for determining the expression of the LRP8
agatgatggactaccctgaggatgg

SEQ ID NO: 191 - DNA, 25 bp, Artificial
  Probe 4 for determining the expression of the LRP8
ccttcgtgcctcatggaattcagtc

SEQ ID NO: 192 - DNA, 25 bp, Artificial
  Probe 5 for determining the expression of the LRP8
tggaattcagtcccatgcactacac

SEQ ID NO: 193 - DNA, 25 bp, Artificial
  Probe 6 for determining the expression of the LRP8
gggtttctatatatgggtctgtgtg

SEQ ID NO: 194 - DNA, 25 bp, Artificial
  Probe 7 for determining the expression of the LRP8
taactggttgcactacccatgagga

SEQ ID NO: 195 - DNA, 25 bp, Artificial
  Probe 8 for determining the expression of the LRP8
ggaattcgtggaatggctactgctg

SEQ ID NO: 196 - DNA, 25 bp, Artificial
  Probe 9 for determining the expression of the LRP8
gatgcacataaccaaatgggggcca

SEQ ID NO: 197 - DNA, 25 bp, Artificial
  Probe 10 for determining the expression of the LRP8
atgggggccaatggcacagtacctt

SEQ ID NO: 198 - DNA, 25 bp, Artificial
  Probe 11 for determining the expression of the LRP8
ggcacagtaccttactcatcattta

SEQ ID NO: 199 - DNA, 25 bp, Artificial
  Probe 1 for determining the expression of the CIAPIN1-2
aatgggatgggtttcttcacctcat

SEQ ID NO: 200 - DNA, 25 bp, Artificial
  Probe 2 for determining the expression of the CIAPIN1-2
aatgctgaccagaacgctcttgagc

SEQ ID NO: 201 - DNA, 25 bp, Artificial
  Probe 3 for determining the expression of the CIAPIN1-2
tgagcccaggcatcgttgagcatta

SEQ ID NO: 202 - DNA, 25 bp, Artificial
  Probe 4 for determining the expression of the CIAPIN1-2
gtctcatctcagcaatgctgccacc

SEQ ID NO: 203 - DNA, 25 bp, Artificial
  Probe 5 for determining the expression of the CIAPIN1-2
gtttactccattctttgtgacacga

SEQ ID NO: 204 - DNA, 25 bp, Artificial
  Probe 6 for determining the expression of the CIAPIN1-2
cacgagtcaagtggctcacaacctc

SEQ ID NO: 205 - DNA, 25 bp, Artificial
  Probe 7 for determining the expression of the CIAPIN1-2
ggactcactcactggttgctgtgat

SEQ ID NO: 206 - DNA, 25 bp, Artificial
  Probe 8 for determining the expression of the CIAPIN1-2
tgtgatgatatccagtgtccctctg

SEQ ID NO: 207 - DNA, 25 bp, Artificial
  Probe 9 for determining the expression of the CIAPIN1-2
atccccaaccacatttgactgtagc

SEQ ID NO: 208 - DNA, 25 bp, Artificial
  Probe 10 for determining the expression of the CIAPIN1-2
gactgtagcattgcatctgtgtcct

SEQ ID NO: 209 - DNA, 25 bp, Artificial
  Probe 11 for determining the expression of the CIAPIN1-2
atctgtgtcctgttgtcatttatgt

SEQ ID NO: 210 - DNA, 25 bp, Artificial
  Probe 1 for determining the expression of the AURKB
gaagagctgcacatttgacgagcag

SEQ ID NO: 211 - DNA, 25 bp, Artificial
  Probe 2 for determining the expression of the AURKB
tgacgagcagcgaacagccacgatc

SEQ ID NO: 212 - DNA, 25 bp, Artificial
  Probe 3 for determining the expression of the AURKB
gatgctctaatgtactgccatggga

SEQ ID NO: 213 - DNA, 25 bp, Artificial
  Probe 4 for determining the expression of the AURKB
gccagaaaatctgctcttagggctc

SEQ ID NO: 214 - DNA, 25 bp, Artificial
  Probe 5 for determining the expression of the AURKB
gaagacaatgtgtggcaccctggac

SEQ ID NO: 215 - DNA, 25 bp, Artificial
  Probe 6 for determining the expression of the AURKB
gaggggcgcatcgacaatgagaagg

SEQ ID NO: 216 - DNA, 25 bp, Artificial
  Probe 7 for determining the expression of the AURKB
agctgctggtggggaacccatttga

SEQ ID NO: 217 - DNA, 25 bp, Artificial
  Probe 8 for determining the expression of the AURKB
gaacccatttgagagtgcatcacac

SEQ ID NO: 218 - DNA, 25 bp, Artificial
  Probe 9 for determining the expression of the AURKB
gcatcacacaacgagacctatcgcc

SEQ ID NO: 219 - DNA, 25 bp, Artificial
  Probe 10 for determining the expression of the AURKB
ctcatctccaaactgctcaggcata

SEQ ID NO: 220 - DNA, 25 bp, Artificial
  Probe 11 for determining the expression of the AURKB
cattcactcgggtgcgtgtgtttgt

SEQ ID NO: 221 - DNA, 25 bp, Artificial
  Probe 1 for determining the expression of the HMMR-2
ttgccctgaagaccccattaaaaga

SEQ ID NO: 222 - DNA, 25 bp, Artificial
  Probe 2 for determining the expression of the HMMR-2
tacaaactgttaccgagctcctatg

SEQ ID NO: 223 - DNA, 25 bp, Artificial
  Probe 3 for determining the expression of the HMMR-2
gattatttcattcgtcttgttgtta

SEQ ID NO: 224 - DNA, 25 bp, Artificial
  Probe 4 for determining the expression of the HMMR-2
cctttcgctggctttccagcttaga

SEQ ID NO: 225 - DNA, 25 bp, Artificial
  Probe 5 for determining the expression of the HMMR-2
ccagcttagaatgcatctcatcaac

SEQ ID NO: 226 - DNA, 25 bp, Artificial
  Probe 6 for determining the expression of the HMMR-2
catattattatcctcctgttctgaa

SEQ ID NO: 227 - DNA, 25 bp, Artificial
  Probe 7 for determining the expression of the HMMR-2
ccccagattcttcagcttgatcctg

SEQ ID NO: 228 - DNA, 25 bp, Artificial
  Probe 8 for determining the expression of the HMMR-2
cttttctagtctgagcttctttagc

SEQ ID NO: 229 - DNA, 25 bp, Artificial
  Probe 9 for determining the expression of the HMMR-2
agctaggctaaaacaccttggcttg

SEQ ID NO: 230 - DNA, 25 bp, Artificial
  Probe 10 for determining the expression of the HMMR-2
accttggcttgttattgcctctact

SEQ ID NO: 231 - DNA, 25 bp, Artificial
  Probe 11 for determining the expression of the HMMR-2
tcacttggtcctacctattatcctt

SEQ ID NO: 232 - DNA, 25 bp, Artificial
  Probe 1 for determining the expression of the CDKN3
tttctcggtttatgtgctcttccag

SEQ ID NO: 233 - DNA, 25 bp, Artificial
  Probe 2 for determining the expression of the CDKN3
tagagtcccaaaccttctggatctc

SEQ ID NO: 234 - DNA, 25 bp, Artificial
  Probe 3 for determining the expression of the CDKN3
ggatctctaccagcaatgtggaatt

SEQ ID NO: 235 - DNA, 25 bp, Artificial
  Probe 4 for determining the expression of the CDKN3
acccatcatcatccaatcgcagatg

SEQ ID NO: 236 - DNA, 25 bp, Artificial
  Probe 5 for determining the expression of the CDKN3
ctcctgacatagccagctgctgtga

SEQ ID NO: 237 - DNA, 25 bp, Artificial
  Probe 6 for determining the expression of the CDKN3
tggaagagcttacaacctgccttaa

SEQ ID NO: 238 - DNA, 25 bp, Artificial
  Probe 7 for determining the expression of the CDKN3
ggaggacttgggagatcttgtcttg

SEQ ID NO: 239 - DNA, 25 bp, Artificial
  Probe 8 for determining the expression of the CDKN3
gacacaatatcaccagagcaagcca

SEQ ID NO: 240 - DNA, 25 bp, Artificial
  Probe 9 for determining the expression of the CDKN3
aagccatagacagcctgcgagacct

SEQ ID NO: 241 - DNA, 25 bp, Artificial
  Probe 10 for determining the expression of the CDKN3
gaggatccggggcaatacagaccat

SEQ ID NO: 242 - DNA, 25 bp, Artificial
  Probe 11 for determining the expression of the CDKN3
attagctgcacatctatcatcaaga

SEQ ID NO: 243 - DNA, 25 bp, Artificial
  Probe 1 for determining the expression of the HSP90AA1
tctgtatggcatgacaactacttta

SEQ ID NO: 244 - DNA, 25 bp, Artificial
  Probe 2 for determining the expression of the HSP90AA1
gatttctgtctactaagtgatgctg

SEQ ID NO: 245 - DNA, 25 bp, Artificial
  Probe 3 for determining the expression of the HSP90AA1
gtgatgctgtgataccttaggcact

SEQ ID NO: 246 - DNA, 25 bp, Artificial
  Probe 4 for determining the expression of the HSP90AA1
gataccttaggcactaaagcagagc

SEQ ID NO: 247 - DNA, 25 bp, Artificial
  Probe 5 for determining the expression of the HSP90AA1
aatgctttttgagtttcatgttggt

SEQ ID NO: 248 - DNA, 25 bp, Artificial
  Probe 6 for determining the expression of the HSP90AA1
gattggggtaacgtgcactgtaaga

SEQ ID NO: 249 - DNA, 25 bp, Artificial
  Probe 7 for determining the expression of the HSP90AA1
gtttagctgtcaagccggatgccta

SEQ ID NO: 250 - DNA, 25 bp, Artificial
  Probe 8 for determining the expression of the HSP90AA1
gccggatgcctaagtagaccaaatc

SEQ ID NO: 251 - DNA, 25 bp, Artificial
  Probe 9 for determining the expression of the HSP90AA1
tgaagtgttctgagctgtatcttga

SEQ ID NO: 252 - DNA, 25 bp, Artificial
  Probe 10 for determining the expression of the HSP90AA1
gtattcgttacatcttgtaggatct

SEQ ID NO: 253 - DNA, 25 bp, Artificial
  Probe 11 for determining the expression of the HSP90AA1
aggatctactttttgaacttttcat

SEQ ID NO: 254 - DNA, 25 bp, Artificial
  Probe 1 for determining the expression of the BRCA1-2
aacaccacatcactttaactaatct

SEQ ID NO: 255 - DNA, 25 bp, Artificial
  Probe 2 for determining the expression of the BRCA1-2 gene
gtagttagctatttctgggtgaccc

SEQ ID NO: 256 - DNA, 25 bp, Artificial
  Probe 3 for determining the expression of the BRCA1-2 gene
accaacatgcccacagatcaactgg

SEQ ID NO: 257 - DNA, 25 bp, Artificial
  Probe 4 for determining the expression of the BRCA1-2 gene
ggtacagctgtgtggtgcttctgtg

SEQ ID NO: 258 - DNA, 25 bp, Artificial
  Probe 5 for determining the expression of the BRCA1-2 gene
gaaggagctttcatcattcaccctt

SEQ ID NO: 259 - DNA, 25 bp, Artificial
  Probe 6 for determining the expression of the BRCA1-2 gene
attcacccttggcacaggtgtccac

SEQ ID NO: 260 - DNA, 25 bp, Artificial
  Probe 7 for determining the expression of the BRCA1-2 gene
ggtgtccacccaattgtggttgtgc

SEQ ID NO: 261 - DNA, 25 bp, Artificial
  Probe 8 for determining the expression of the BRCA1-2 gene
ggttgtgcagccagatgcctggaca

SEQ ID NO: 262 - DNA, 25 bp, Artificial
  Probe 9 for determining the expression of the BRCA1-2 gene
aggcacctgtggtgacccgagagtg

SEQ ID NO: 263 - DNA, 25 bp, Artificial
  Probe 10 for determining the expression of the BRCA1-2 gene
gtagcactctaccagtgccaggagc

SEQ ID NO: 264 - DNA, 25 bp, Artificial
  Probe 11 for determining the expression of the BRCA1-2 gene
tgccaggagctggacacctacctga

SEQ ID NO: 265 - DNA, 25 bp, Artificial
  Probe 1 for determining the expression of the HSP90AA1-2 gene
gtacgcagagttttcatcatggata

SEQ ID NO: 266 - DNA, 25 bp, Artificial
  Probe 2 for determining the expression of the HSP90AA1-2 gene
ggagctaatccctgaatatctgaac

SEQ ID NO: 267 - DNA, 25 bp, Artificial
  Probe 3 for determining the expression of the HSP90AA1-2 gene
ggtggtagactcggaggatctccct

SEQ ID NO: 268 - DNA, 25 bp, Artificial
  Probe 4 for determining the expression of the HSP90AA1-2 gene
tctccctctaaacatatcccgtgag

SEQ ID NO: 269 - DNA, 25 bp, Artificial
  Probe 5 for determining the expression of the HSP90AA1-2 gene
tgttaaggtactacacatctgcctc

SEQ ID NO: 270 - DNA, 25 bp, Artificial
  Probe 6 for determining the expression of the HSP90AA1-2 gene
gtttctctcaaggactactgcacca

SEQ ID NO: 271 - DNA, 25 bp, Artificial
  Probe 7 for determining the expression of the HSP90AA1-2 gene
ggaccaggtagctaactcagccttt

SEQ ID NO: 272 - DNA, 25 bp, Artificial
  Probe 8 for determining the expression of the HSP90AA1-2 gene
tcagcctttgtggaacgtcttcgga

SEQ ID NO: 273 - DNA, 25 bp, Artificial
  Probe 9 for determining the expression of the HSP90AA1-2 gene
gaacgtcttcggaaacatggcttag

SEQ ID NO: 274 - DNA, 25 bp, Artificial
  Probe 10 for determining the expression of the HSP90AA1-2 gene
gattgagcccattgatgagtactgt

SEQ ID NO: 275 - DNA, 25 bp, Artificial
  Probe 11 for determining the expression of the HSP90AA1-2  gene
ggaagactttagtgtcagtcaccaa

SEQ ID NO: 276 - DNA, 25 bp, Artificial
  Probe 1 for determining the expression of the HSP90AA1-3 gene
gagctgcatattaaccttataccga

SEQ ID NO: 277 - DNA, 25 bp, Artificial
  Probe 2 for determining the expression of the HSP90AA1-3 gene
aagatcgaactctcactattgtgga

SEQ ID NO: 278 - DNA, 25 bp, Artificial
  Probe 3 for determining the expression of the HSP90AA1-3 gene
ggtactatcgccaagtctgggacca

SEQ ID NO: 279 - DNA, 25 bp, Artificial
  Probe 4 for determining the expression of the HSP90AA1-3 gene
ggaagctttgcaggctggtgcagat

SEQ ID NO: 280 - DNA, 25 bp, Artificial
  Probe 5 for determining the expression of the HSP90AA1-3 gene
atctctatgattggccagttcggtg

SEQ ID NO: 281 - DNA, 25 bp, Artificial
  Probe 6 for determining the expression of the HSP90AA1-3 gene
gttcggtgttggtttttattctgct

SEQ ID NO: 282 - DNA, 25 bp, Artificial
  Probe 7 for determining the expression of the HSP90AA1-3 gene
atgagcagtacgcttgggagtcctc

SEQ ID NO: 283 - DNA, 25 bp, Artificial
  Probe 8 for determining the expression of the HSP90AA1-3 gene
cctcagcagggggatcattcacagt

SEQ ID NO: 284 - DNA, 25 bp, Artificial
  Probe 9 for determining the expression of the HSP90AA1-3 gene
cacaggtgaacctatgggtcgtgga

SEQ ID NO: 285 - DNA, 25 bp, Artificial
  Probe 10 for determining the expression of the HSP90AA1-3 gene
gaacaaaagttatcctacacctgaa

SEQ ID NO: 286 - DNA, 25 bp, Artificial
  Probe 11 for determining the expression of the HSP90AA1-3 gene
tggatatcccattactctttttgtg

SEQ ID NO: 287 - DNA, 25 bp, Artificial
  Probe 1 for determining the expression of the HSP90AA1-4 gene
ccctgtagttgacaattctgcatgt

SEQ ID NO: 288 - DNA, 25 bp, Artificial
  Probe 2 for determining the expression of the HSP90AA1-4 gene
aattctgcatgtactagtcctctag

SEQ ID NO: 289 - DNA, 25 bp, Artificial
  Probe 3 for determining the expression of the HSP90AA1-4 gene
gatggaaggatctctccacagggct

SEQ ID NO: 290 - DNA, 25 bp, Artificial
  Probe 4 for determining the expression of the HSP90AA1-4 gene
tctccacagggcttgttttccaaag

SEQ ID NO: 291 - DNA, 25 bp, Artificial
  Probe 5 for determining the expression of the HSP90AA1-4 gene
gagcaaagttaaaagcctacctaag

SEQ ID NO: 292 - DNA, 25 bp, Artificial
  Probe 6 for determining the expression of the HSP90AA1-4 gene
aaagcctacctaagcatatcgtaaa

SEQ ID NO: 293 - DNA, 25 bp, Artificial
  Probe 7 for determining the expression of the HSP90AA1-4 gene
gcatatcgtaaagctgttcaaaaat

SEQ ID NO: 294 - DNA, 25 bp, Artificial
  Probe 8 for determining the expression of the HSP90AA1-4 gene
caaaaataactcagacccagtcttg

SEQ ID NO: 295 - DNA, 25 bp, Artificial
  Probe 9 for determining the expression of the HSP90AA1-4 gene
tcagacccagtcttgtggatggaaa

SEQ ID NO: 296 - DNA, 25 bp, Artificial
  Probe 10 for determining the expression of the HSP90AA1-4 gene
ggatggaaatgtagtgctcgagtca

SEQ ID NO: 297 - DNA, 25 bp, Artificial
  Probe 11 for determining the expression of the HSP90AA1-4 gene
tgctcgagtcacattctgcttaaag

SEQ ID NO: 298 - DNA, 25 bp, Artificial
  Probe 1 for determining the expression of the NUSAP1 gene
aactgcagtcttctgctagccaata

SEQ ID NO: 299 - DNA, 25 bp, Artificial
  Probe 2 for determining the expression of the NUSAP1 gene
gggatagaaaggccacctcttcact

SEQ ID NO: 300 - DNA, 25 bp, Artificial
  Probe 3 for determining the expression of the NUSAP1 gene
cacctcttcactctctatagaatat

SEQ ID NO: 301 - DNA, 25 bp, Artificial
  Probe 4 for determining the expression of the NUSAP1 gene
tgtaccttcgttcaaatatcctcat

SEQ ID NO: 302 - DNA, 25 bp, Artificial
  Probe 5 for determining the expression of the NUSAP1 gene
tcctcatgtaattgccatctgtcac

SEQ ID NO: 303 - DNA, 25 bp, Artificial
  Probe 6 for determining the expression of the NUSAP1 gene
catctgtcactcactatattcacaa

SEQ ID NO: 304 - DNA, 25 bp, Artificial
  Probe 7 for determining the expression of the NUSAP1 gene
actcattctaacattgcttacttaa

SEQ ID NO: 305 - DNA, 25 bp, Artificial
  Probe 8 for determining the expression of the NUSAP1 gene
gctacatagccctatcgaaatgcga

SEQ ID NO: 306 - DNA, 25 bp, Artificial
  Probe 9 for determining the expression of the NUSAP1 gene
ggctttgcttagtatcatgtccatg

SEQ ID NO: 307 - DNA, 25 bp, Artificial
  Probe 10 for determining the expression of the NUSAP1 gene
ccttcacctcagtggagcttctgag

SEQ ID NO: 308 - DNA, 25 bp, Artificial
  Probe 11 for determining the expression of the NUSAP1 gene
gttttatactgctcaagatcgtcat

SEQ ID NO: 309 - DNA, 25 bp, Artificial
  Probe 1 for determining the expression of the ERO1L gene
tcaagttccaatctaaagttctttt

SEQ ID NO: 310 - DNA, 25 bp, Artificial
  Probe 2 for determining the expression of the ERO1L gene
gagttttgttgcccgttttatgctt

SEQ ID NO: 311 - DNA, 25 bp, Artificial
  Probe 3 for determining the expression of the ERO1L gene
gttgcccgttttatgcttgatgtgt

SEQ ID NO: 312 - DNA, 25 bp, Artificial
  Probe 4 for determining the expression of the ERO1L gene
ctggaacttgaacgactgggctgaa

SEQ ID NO: 313 - DNA, 25 bp, Artificial
  Probe 5 for determining the expression of the ERO1L gene
tacccgaagttcatttcctttgtct

SEQ ID NO: 314 - DNA, 25 bp, Artificial
  Probe 6 for determining the expression of the ERO1L gene
tcctttgtctccctaaaactgaact

SEQ ID NO: 315 - DNA, 25 bp, Artificial
  Probe 7 for determining the expression of the ERO1L gene
ggttttcattagtggaagctcttca

SEQ ID NO: 316 - DNA, 25 bp, Artificial
  Probe 8 for determining the expression of the ERO1L gene
ggggtttaggaatttatatcacatg

SEQ ID NO: 317 - DNA, 25 bp, Artificial
  Probe 9 for determining the expression of the ERO1L gene
ctatatacctcaaaatcgtgccctc

SEQ ID NO: 318 - DNA, 25 bp, Artificial
  Probe 10 for determining the expression of the ERO1L gene
gtgccctctttacatatgtcttatc

SEQ ID NO: 319 - DNA, 25 bp, Artificial
  Probe 11 for determining the expression of the ERO1L gene
atgtcagtttacactgctgtatact

SEQ ID NO: 320 - DNA, 25 bp, Artificial
  Probe 1 for determining the expression of the MLF1IP gene
aaacgtatgattcatccagccttcc

SEQ ID NO: 321 - DNA, 25 bp, Artificial
  Probe 2 for determining the expression of the MLF1IP gene
aagaacacttctgggagccgaaagc

SEQ ID NO: 322 - DNA, 25 bp, Artificial
  Probe 3 for determining the expression of the MLF1IP gene
ggagccgaaagccatctgcgaaata

SEQ ID NO: 323 - DNA, 25 bp, Artificial
  Probe 4 for determining the expression of the MLF1IP gene
gccatctgcgaaatatcaaccatca

SEQ ID NO: 324 - DNA, 25 bp, Artificial
  Probe 5 for determining the expression of the MLF1IP gene
caaccatcagttagagaagctcctt

SEQ ID NO: 325 - DNA, 25 bp, Artificial
  Probe 6 for determining the expression of the MLF1IP gene
gaagctccttgaccagggatgagaa

SEQ ID NO: 326 - DNA, 25 bp, Artificial
  Probe 7 for determining the expression of the MLF1IP gene
gtgcctataggaagactagtctcat

SEQ ID NO: 327 - DNA, 25 bp, Artificial
  Probe 8 for determining the expression of the MLF1IP gene
aaatagcatcagtttgtccaatagt

SEQ ID NO: 328 - DNA, 25 bp, Artificial
  Probe 9 for determining the expression of the MLF1IP gene
aggccataatcatcttttctggtta

SEQ ID NO: 329 - DNA, 25 bp, Artificial
  Probe 10 for determining the expression of the MLF1IP gene
atgttgacaccttaatcggtcccag

SEQ ID NO: 330 - DNA, 25 bp, Artificial
  Probe 11 for determining the expression of the MLF1IP gene
atcggtcccaggtatgagctataat

SEQ ID NO: 331 - DNA, 25 bp, Artificial
  Probe 1 for determining the expression of the DCC1 gene
tcaagtgagtgagttcccctctact

SEQ ID NO: 332 - DNA, 25 bp, Artificial
  Probe 2 for determining the expression of the DCC1 gene
gccttccacccaaactggaagcctc

SEQ ID NO: 333 - DNA, 25 bp, Artificial
  Probe 3 for determining the expression of the DCC1 gene
ggaagcctctaggtgctatcaatta

SEQ ID NO: 334 - DNA, 25 bp, Artificial
  Probe 4 for determining the expression of the DCC1 gene
attggctgaataattactcctctgc

SEQ ID NO: 335 - DNA, 25 bp, Artificial
  Probe 5 for determining the expression of the DCC1 gene
gaatactggcacaggcaatgctcac

SEQ ID NO: 336 - DNA, 25 bp, Artificial
  Probe 6 for determining the expression of the DCC1 gene
tggcacaggcaatgctcactcgaaa

SEQ ID NO: 337 - DNA, 25 bp, Artificial
  Probe 7 for determining the expression of the DCC1 gene
tctagttggttttggaatgcttgat

SEQ ID NO: 338 - DNA, 25 bp, Artificial
  Probe 8 for determining the expression of the DCC1 gene
agctaatgaactcatcaccaggaca

SEQ ID NO: 339 - DNA, 25 bp, Artificial
  Probe 9 for determining the expression of the DCC1 gene
ggacagttggagggggtaggccgag

SEQ ID NO: 340 - DNA, 25 bp, Artificial
  Probe 10 for determining the expression of the DCC1 gene
gtaggccgaggttaaatggtccacg

SEQ ID NO: 341 - DNA, 25 bp, Artificial
  Probe 11 for determining the expression of the DCC1 gene
tggtccacgtttcaaaaatgttaat

SEQ ID NO: 342 - DNA, 25 bp, Artificial
  Probe 1 for determining the expression of the C21orf45 gene
agccaggaggacaccaactgcatcc

SEQ ID NO: 343 - DNA, 25 bp, Artificial
  Probe 2 for determining the expression of the C21orf45 gene
gtgtttcctgtaatgtttctgtgga

SEQ ID NO: 344 - DNA, 25 bp, Artificial
  Probe 3 for determining the expression of the C21orf45 gene
gcgtccttgagactttgtgctgcgc

SEQ ID NO: 345 - DNA, 25 bp, Artificial
  Probe 4 for determining the expression of the C21orf45 gene
tgctcactcaatcttggctacgtgt

SEQ ID NO: 346 - DNA, 25 bp, Artificial
  Probe 5 for determining the expression of the C21orf45 gene
ggctacgtgtacagatgcacgccca

SEQ ID NO: 347 - DNA, 25 bp, Artificial
  Probe 6 for determining the expression of the C21orf45 gene
cagatgcacgcccaagaatcttgat

SEQ ID NO: 348 - DNA, 25 bp, Artificial
  Probe 7 for determining the expression of the C21orf45 gene
gagagacttgttttgcctcagtgtt

SEQ ID NO: 349 - DNA, 25 bp, Artificial
  Probe 8 for determining the expression of the C21orf45 gene
gttttgcctcagtgttgaagccatt

SEQ ID NO: 350 - DNA, 25 bp, Artificial
  Probe 9 for determining the expression of the C21orf45 gene
gaaagttatgttttagggtcctctg

SEQ ID NO: 351 - DNA, 25 bp, Artificial
  Probe 10 for determining the expression of the C21orf45 gene
gggaggccgaatccaaattgtcctt

SEQ ID NO: 352 - DNA, 25 bp, Artificial
  Probe 11 for determining the expression of the C21orf45 gene
aagctgaactctagtctgtgtcctc

SEQ ID NO: 353 - DNA, 25 bp, Artificial
  Probe 1 for determining the expression of the PBK gene
agcatactatgcagcgttgggaact

SEQ ID NO: 354 - DNA, 25 bp, Artificial
  Probe 2 for determining the expression of the PBK gene
cagcgttgggaactaggccacctat

SEQ ID NO: 355 - DNA, 25 bp, Artificial
  Probe 3 for determining the expression of the PBK gene
tgaactcttctctgtatgcactaat

SEQ ID NO: 356 - DNA, 25 bp, Artificial
  Probe 4 for determining the expression of the PBK gene
agaccctaaagatcgtccttctgct

SEQ ID NO: 357 - DNA, 25 bp, Artificial
  Probe 5 for determining the expression of the PBK gene
atgtctagtgatcatctcagctgaa

SEQ ID NO: 358 - DNA, 25 bp, Artificial
  Probe 6 for determining the expression of the PBK gene
gtgtggcttgcgtaaataactgttt

SEQ ID NO: 359 - DNA, 25 bp, Artificial
  Probe 7 for determining the expression of the PBK gene
gaggaccatagtttcttgttaacat

SEQ ID NO: 360 - DNA, 25 bp, Artificial
  Probe 8 for determining the expression of the PBK gene
aagcacttggaattgtactgggttt

SEQ ID NO: 361 - DNA, 25 bp, Artificial
  Probe 9 for determining the expression of the PBK gene
gtactttgatactgctcatgctgac

SEQ ID NO: 362 - DNA, 25 bp, Artificial
  Probe 10 for determining the expression of the PBK gene
tgctcatgctgacttaaaacactag

SEQ ID NO: 363 - DNA, 25 bp, Artificial
  Probe 11 for determining the expression of the PBK gene
ggatctactgacattagcactttgt

SEQ ID NO: 364 - DNA, 25 bp, Artificial
  Probe 1 for determining the expression of the ATAD5 gene
gggataaagctagattcttccaaag

SEQ ID NO: 365 - DNA, 25 bp, Artificial
  Probe 2 for determining the expression of the ATAD5 gene
caacctcagactgccagtgaactta

SEQ ID NO: 366 - DNA, 25 bp, Artificial
  Probe 3 for determining the expression of the ATAD5 gene
agatttctcgggtggcatagacttt

SEQ ID NO: 367 - DNA, 25 bp, Artificial
  Probe 4 for determining the expression of the ATAD5 gene
gagagtcgtctttgcaatactgtcc

SEQ ID NO: 368 - DNA, 25 bp, Artificial
  Probe 5 for determining the expression of the ATAD5 gene
atactgtccttataacagggccaac

SEQ ID NO: 369 - DNA, 25 bp, Artificial
  Probe 6 for determining the expression of the ATAD5 gene
tgctgcagtgtatgcttgtgcccag

SEQ ID NO: 370 - DNA, 25 bp, Artificial
  Probe 7 for determining the expression of the ATAD5 gene
tttgaagtgaatgcctcttcccagc

SEQ ID NO: 371 - DNA, 25 bp, Artificial
  Probe 8 for determining the expression of the ATAD5 gene
ctcttcccagcgcagtggtagacaa

SEQ ID NO: 372 - DNA, 25 bp, Artificial
  Probe 9 for determining the expression of the ATAD5 gene
gaagctactcagtcccatcaagtag

SEQ ID NO: 373 - DNA, 25 bp, Artificial
  Probe 10 for determining the expression of the ATAD5 gene
gctactacataggcaagtcaccaag

SEQ ID NO: 374 - DNA, 25 bp, Artificial
  Probe 11 for determining the expression of the ATAD5 gene
aactattttccttaagccataatgt

SEQ ID NO: 375 - DNA, 25 bp, Artificial
  Probe 1 for determining the expression of the MCM10 gene
cagccttaaataacccgaacttcag

SEQ ID NO: 376 - DNA, 25 bp, Artificial
  Probe 2 for determining the expression of the MCM10 gene
ggattggctgtgtattgtccattga

SEQ ID NO: 377 - DNA, 25 bp, Artificial
  Probe 3 for determining the expression of the MCM10 gene
tccattgattcctgattgacgccgt

SEQ ID NO: 378 - DNA, 25 bp, Artificial
  Probe 4 for determining the expression of the MCM10 gene
gttaagcccataagctttgcctgct

SEQ ID NO: 379 - DNA, 25 bp, Artificial
  Probe 5 for determining the expression of the MCM10 gene
taagctttgcctgcttactttctgc

SEQ ID NO: 380 - DNA, 25 bp, Artificial
  Probe 6 for determining the expression of the MCM10 gene
gcttactttctgccattgggttggt

SEQ ID NO: 381 - DNA, 25 bp, Artificial
  Probe 7 for determining the expression of the MCM10 gene
aaccaagttatcattgtcttttcta

SEQ ID NO: 382 - DNA, 25 bp, Artificial
  Probe 8 for determining the expression of the MCM10 gene
gtcttttctaagctcagtgtggatg

SEQ ID NO: 383 - DNA, 25 bp, Artificial
  Probe 9 for determining the expression of the MCM10 gene
gtttatacgaacacccagaggcaaa

SEQ ID NO: 384 - DNA, 25 bp, Artificial
  Probe 10 for determining the expression of the MCM10 gene
atttggcttaattctcactccaggt

SEQ ID NO: 385 - DNA, 25 bp, Artificial
  Probe 11 for determining the expression of the MCM10 gene
agtagcttaacttctgggcttcagt

SEQ ID NO: 386 - DNA, 25 bp, Artificial
  Probe 1 for determining the expression of the CDCA3 gene
gcacggacacctatgaagaccagca

SEQ ID NO: 387 - DNA, 25 bp, Artificial
  Probe 2 for determining the expression of the CDCA3 gene
ccccaagcccactggtgaaacagct

SEQ ID NO: 388 - DNA, 25 bp, Artificial
  Probe 3 for determining the expression of the CDCA3 gene
ccagaggcacctttatcttctgaat

SEQ ID NO: 389 - DNA, 25 bp, Artificial
  Probe 4 for determining the expression of the CDCA3 gene
ctgaattggacttgcctctgggtac

SEQ ID NO: 390 - DNA, 25 bp, Artificial
  Probe 5 for determining the expression of the CDCA3 gene
ccagatcttcaggttctatgcgcaa

SEQ ID NO: 391 - DNA, 25 bp, Artificial
  Probe 6 for determining the expression of the CDCA3 gene
gcaaggtactagggagatcccccct

SEQ ID NO: 392 - DNA, 25 bp, Artificial
  Probe 7 for determining the expression of the CDCA3 gene
tcctgcaggatgacaactcccctgg

SEQ ID NO: 393 - DNA, 25 bp, Artificial
  Probe 8 for determining the expression of the CDCA3 gene
tacgacagggtaagcggccttcacc

SEQ ID NO: 394 - DNA, 25 bp, Artificial
  Probe 9 for determining the expression of the CDCA3 gene
ggagccattcttggaactggacgac

SEQ ID NO: 395 - DNA, 25 bp, Artificial
  Probe 10 for determining the expression of the CDCA3 gene
gagcaaggccaggaccatgacaagg

SEQ ID NO: 396 - DNA, 25 bp, Artificial
  Probe 11 for determining the expression of the CDCA3 gene
aaaatcagcactttcccttggtgga

SEQ ID NO: 397 - DNA, 25 bp, Artificial
  Probe 1 for determining the expression of the RACGAP1 gene
gtacaactcgtatttatctctgatg

SEQ ID NO: 398 - DNA, 25 bp, Artificial
  Probe 2 for determining the expression of the RACGAP1 gene
caatatatcatcctttggcatccca

SEQ ID NO: 399 - DNA, 25 bp, Artificial
  Probe 3 for determining the expression of the RACGAP1 gene
agctacagtcattttttctttgcac

SEQ ID NO: 400 - DNA, 25 bp, Artificial
  Probe 4 for determining the expression of the RACGAP1 gene
ttttctttgcactttggatgctgaa

SEQ ID NO: 401 - DNA, 25 bp, Artificial
  Probe 5 for determining the expression of the RACGAP1 gene
ggatgctgaaatttttcccatggaa

SEQ ID NO: 402 - DNA, 25 bp, Artificial
  Probe 6 for determining the expression of the RACGAP1 gene
ttcccatggaacatagccacatcta

SEQ ID NO: 403 - DNA, 25 bp, Artificial
  Probe 7 for determining the expression of the RACGAP1 gene
tctagatagatgtgagctttttctt

SEQ ID NO: 404 - DNA, 25 bp, Artificial
  Probe 8 for determining the expression of the RACGAP1 gene
aaacgattttcttctgtagaatgtt

SEQ ID NO: 405 - DNA, 25 bp, Artificial
  Probe 9 for determining the expression of the RACGAP1 gene
gaatgtttgacttcgtattgaccct

SEQ ID NO: 406 - DNA, 25 bp, Artificial
  Probe 10 for determining the expression of the RACGAP1 gene
acttcgtattgacccttatctgtaa

SEQ ID NO: 407 - DNA, 25 bp, Artificial
  Probe 11 for determining the expression of the RACGAP1 gene
atctgtaaaacacctatttgggata

SEQ ID NO: 408 - DNA, 25 bp, Artificial
  Probe 1 for determining the expression of the ELOVL5 gene
agatgtgtttagaacctcttgttta

SEQ ID NO: 409 - DNA, 25 bp, Artificial
  Probe 2 for determining the expression of the ELOVL5 gene
tatcataaaatcacatctcacacat

SEQ ID NO: 410 - DNA, 25 bp, Artificial
  Probe 3 for determining the expression of the ELOVL5 gene
aatttagcctctgaataccttctcc

SEQ ID NO: 411 - DNA, 25 bp, Artificial
  Probe 4 for determining the expression of the ELOVL5 gene
ttcttggaaccactcatgacatatc

SEQ ID NO: 412 - DNA, 25 bp, Artificial
  Probe 5 for determining the expression of the ELOVL5 gene
gcacattcgtactatagggagccta

SEQ ID NO: 413 - DNA, 25 bp, Artificial
  Probe 6 for determining the expression of the ELOVL5 gene
gggagcctattggttctctattagt

SEQ ID NO: 414 - DNA, 25 bp, Artificial
  Probe 7 for determining the expression of the ELOVL5 gene
ctctattagtcttgtgggttttctg

SEQ ID NO: 415 - DNA, 25 bp, Artificial
  Probe 8 for determining the expression of the ELOVL5 gene
ggagtcatggcatctgtttacattt

SEQ ID NO: 416 - DNA, 25 bp, Artificial
  Probe 9 for determining the expression of the ELOVL5 gene
gtatgtcttcattgctaggtactaa

SEQ ID NO: 417 - DNA, 25 bp, Artificial
  Probe 10 for determining the expression of the ELOVL5 gene
ggtactaatttgcagatgtctttac

SEQ ID NO: 418 - DNA, 25 bp, Artificial
  Probe 11 for determining the expression of the ELOVL5 gene
agctcacctggatatacctacattg

SEQ ID NO: 419 - DNA, 25 bp, Artificial
  Probe 1 for determining the expression of the PARP3 gene
tggcaccaacatggccgtggtggcc

SEQ ID NO: 420 - DNA, 25 bp, Artificial
  Probe 2 for determining the expression of the PARP3 gene
tctggtgggcgtgttggcaagggca

SEQ ID NO: 421 - DNA, 25 bp, Artificial
  Probe 3 for determining the expression of the PARP3 gene
gcaagggcatctactttgcctcaga

SEQ ID NO: 422 - DNA, 25 bp, Artificial
  Probe 4 for determining the expression of the PARP3 gene
tcggctacatgttcctgggtgaggt

SEQ ID NO: 423 - DNA, 25 bp, Artificial
  Probe 5 for determining the expression of the PARP3 gene
gggcagagagcaccatatcaacacg

SEQ ID NO: 424 - DNA, 25 bp, Artificial
  Probe 6 for determining the expression of the PARP3 gene
tggcttcgacagtgtcattgcccga

SEQ ID NO: 425 - DNA, 25 bp, Artificial
  Probe 7 for determining the expression of the PARP3 gene
atccgacccaggacactgagttgga

SEQ ID NO: 426 - DNA, 25 bp, Artificial
  Probe 8 for determining the expression of the PARP3 gene
tctaccaggagagccagtgtcgcct

SEQ ID NO: 427 - DNA, 25 bp, Artificial
  Probe 9 for determining the expression of the PARP3 gene
gggtcctgcaaggctggactgtgat

SEQ ID NO: 428 - DNA, 25 bp, Artificial
  Probe 10 for determining the expression of the PARP3 gene
gactgtgatcttcaatcatcctgcc

SEQ ID NO: 429 - DNA, 25 bp, Artificial
  Probe 11 for determining the expression of the PARP3 gene
ccctatatcactcctttttttcaag

SEQ ID NO: 430 - DNA, 25 bp, Artificial
  Probe 1 for determining the expression of the CBX7 gene
ccccacccgctttgaatgtagagac

SEQ ID NO: 431 - DNA, 25 bp, Artificial
  Probe 2 for determining the expression of the CBX7 gene
tgtagagacccgtgggcacttttcc

SEQ ID NO: 432 - DNA, 25 bp, Artificial
  Probe 3 for determining the expression of the CBX7 gene
cacagccgcctggaatgcaggactg

SEQ ID NO: 433 - DNA, 25 bp, Artificial
  Probe 4 for determining the expression of the CBX7 gene
cactgctgttcgggtgatgacctcg

SEQ ID NO: 434 - DNA, 25 bp, Artificial
  Probe 5 for determining the expression of the CBX7 gene
gctgtgcttctgtgaggtggtttag

SEQ ID NO: 435 - DNA, 25 bp, Artificial
  Probe 6 for determining the expression of the CBX7 gene
gctttcgaagtggccagctgcggcc

SEQ ID NO: 436 - DNA, 25 bp, Artificial
  Probe 7 for determining the expression of the CBX7 gene
ccaggtctcagcacaagagcgcttc

SEQ ID NO: 437 - DNA, 25 bp, Artificial
  Probe 8 for determining the expression of the CBX7 gene
agcgcttcctttgcacagaatgagc

SEQ ID NO: 438 - DNA, 25 bp, Artificial
  Probe 9 for determining the expression of the CBX7 gene
agcttcgagctttgttcagactaaa

SEQ ID NO: 439 - DNA, 25 bp, Artificial
  Probe 10 for determining the expression of the CBX7 gene
gtcgggggcacgagttgattccaag

SEQ ID NO: 440 - DNA, 25 bp, Artificial
  Probe 11 for determining the expression of the CBX7 gene
gattccaagcacatgcctttgctga